(19) United States
(12) Patent Application Publication
(10) Pub. No.: US 2015/0326701 A1
(43) Pub. Date: Nov. 12, 2015

(54) INTEGRATED COMMUNICATION CENTER FOR HOTEL GUESTS

(71) Applicant: FINGI INC., Suite #102, NY (US)

(72) Inventors: Jacob Morris ROBFOGEL, NEW YORK, NY (US); Robinus VAN DEN IJSSEL, New York, NY (US); Eran SHERIN, New York, NY (US); Bradley PERKINS, New York, NY (US)

(21) Appl. No.: 14/411,898

(22) PCT Filed: Nov. 8, 2012
(86) PCT No.: PCT/US12/64237

§ 371 Date: Dec. 29, 2014

Related U.S. Application Data
(60) Provisional application No. 61/668,979, filed on Jul. 6, 2012.

(51) Int. Cl. H04M 1/21

(52) U.S. Cl. CPC H04M 1/21; H04M 2203/1083

(57) ABSTRACT

This disclosure is directed at an electronic device for hotel rooms which performs a number of functions currently performed by several different devices in hotel rooms, such as clocks, phones, thermostats, and sound systems, as well as a number of functions not performed by current devices. The goal of the device is to eliminate the need for a number of discrete devices while providing a device which performs these same tasks better, through integration of features and network functionality.

### CROSS-REFERENCES TO RELATED APPLICATION

The present application claims priority to U.S. Provisional Application No. 61/668,979, filed Jul. 6, 2012, and entitled “Information And Control System For Life Activities,” and to PCT/US2012/058134, filed Sep. 28, 2012, entitled “Methods And Mobile Devices That Allow Hotel Guests To Interface With The Hotel Via The Mobile Device,” the entirety of which is hereby incorporated by reference.

### FIELD OF THE DISCLOSURE

The subject invention relates to methods, network systems, electronic devices that allow a hotel guest to interface with a hotel.

### BACKGROUND OF THE DISCLOSURE

The hotel industry, serving millions of travelers each year, has been required to install an ever increasing number of electronic devices in each of their rooms, causing a number of problems for the hotel. Increasingly, much of the available surface area in a room is covered with electronic devices performing different functions which a guest requires. Often a bedside table alone will have an alarm clock, a phone system, and a sound system, leaving little room for the guest to use.

Additionally, these systems are often difficult for a guest to use, and may not even be set up properly when the guest arrives. The guest may attempt to set up the devices to their liking themselves, however, systems will often be new to the guest and their chances of success for something as simple as setting the correct time on the clock may be low. Even if the device is set up properly to a guest's liking, there is often no way to reset the device for the next guest, who may, for instance, not appreciate the alarm at 5 am which the last guest had left in the alarm clock.

Even a technically savvy guest can be frustrated by current hotel room electronics because they are often not compatible with the guest's electronics. For instance, even if the room has a sound system with an iPod® dock, there is no saying whether or not the device was made compatible with the guests iPod®, which may be of the wrong generation, not to mention the many guests with competing products such as a Zune® or an Android® phone.

In a room where the user has no compatible dock for their electronic devices, they will need to have brought a wall charger for the device and then must find an electrical outlet, perhaps having to shift around furniture to find one.

These current systems are not just a problem for guests but also for hotel operators. Often devices which work with the current generation of mobile devices will be obsolete within a few short years, requiring massive overhauls to meet the new generation. Additionally, there is often no way to update the software of such devices to fix bugs, change settings, or update compatibility or capability.

### SUMMARY OF THE DISCLOSURE

This disclosure is directed at an Integrated Guest Communication Center (IGCC), which is an electronic device for hotel rooms which performs a number of functions currently performed by several different devices in hotel rooms, such as clocks, phones, thermostats, and sound systems, as well as a number of functions not performed by current devices. The goal of the device is to eliminate the need for a number of discrete devices while providing a device which performs these same tasks better, through integration of features and network functionality.

The IGCC in the preferred embodiment is a networked electronic device consisting of a number of components which give it many diverse capabilities. The IGCC has a display and input means, one or more docks for a guest's portable electronics, a speakerphone system, an alarm clock, an audio system, USB inputs and power, and a room thermostat.

When a guest arrives at a hotel room equipped with an IGCC, they will be able to use it to perform a great deal of functions which would otherwise each be on discrete systems. For instance, the device will operate at the most basic level as an alarm clock radio, displaying the time, allowing for alarms to be set, and allowing music to be played from web based radio stations. The IGCC also operates as the room thermostat, having built-in temperature settings and having the ability to change the room temperature by accessing the networked AC unit in the room. The device may also replace the room phone through its built-in IP phone capabilities, speakers and microphone, or through a dedicated USB handset which can be plugged into a USB port set aside for this use.

The device also allows for the use of existing IP Phone and SIP technology to be able to communicate with other SIP and VOIP clients including other IGCC units as well as software and hardware devices configured with a SIP or other type of VOIP address.

Another use to which the IGCC can be put is one which has become increasingly important to world travelers: the ability to charge and interact with portable electronic devices, such as an iPod®, iPhone®, iPad®, Android® phone, tablets, or any other USB connected device. The IGCC can at least charge these devices, and with the proper drivers, can interact with them further, such as playing music from them.

The device integrates various wireless communication means as well, including Bluetooth® connections and Wi-Fi. The device can be set up as a Wi-Fi hotspot for a room as well, if there is an Ethernet or DSL connection in the room. If not, the device can use a hotel's Wi-Fi to access the hotel's network and internet itself without a wired connection.

The network connection of the device allows a number of useful applications as well. The hotel property with an integrated property management system (PMS) can set the device to reset each time a new guest checks in to the room, or even to have the device revert to the settings which that particular guest last used on another IGCC, perhaps even in another hotel. The system will also be able to report its state or any malfunctions to the hotel management, or even directly to the maintenance personnel, as well as support staff. Software updates, as well, can be performed remotely, allowing the IGCC to be updated with new functions or additional device drivers, as well as to change settings or fix bugs.

When used as part of a hotel guest platform, including operational services, room controls, a mobile app and web portals, the IGCC can interact with those systems. For example, a guest may interact with the mobile app to set preferences for the IGCC, such as time format (24H v. 12H), temperature form (° C. v. ° F.), set the alarm time for the IGCC, or manually enter an Internet radio station (to supplement preset stations in the IGCC). Additionally, the IGCC can be used in non-hospitality settings, such as offices, residential building and even in private homes. In such environments, the IGCC can connect to a world-wide server operated to support such IGCC uses.

When used in combination with other applications that can store user data and preferences, users of the IGCC can also save their custom settings and preferences to be applied either automatically or by user configuration.

Additional features include automatically customizing the language displayed by the device based on the guest's country of origin (from the PMS) or preferences stored by the IGCC operational server. The IGCC is interfaced with the hotel's telephone system, allowing the guest to have access to the voicemail system, both through audio and screen commands. Additionally, when operating in the telephone mode, the IGCC can display a list of services that can be selected by the guest and dialed.

The hotel guest can select from a variety alarm types in the IGCC, including various alarm tones (steady tone, gradually increasing tone, etc.), audio sources (Internet radio, connected mobile devices, etc.), operate other in-room functions (open curtains, turn on television to selected channel, turn on lights, or combination, possibly stored as moods) through the operational server and connected room control systems. Because the IGCC can monitor these audio sources, and possible the ambient sound in the room (using the built-in microphone), the IGCC includes an alarm fail-safe system that makes sure that some sound is produced when the alarm is to sound. Additionally, snooze settings can be configured by the hotel—i.e. length of snooze time. Such settings can be retrieved as preferences stored in the hotel's operational server.

The IGCC is completely customizable by the hotel, including look and feel, logos, services names, etc. Additionally, all guest preference can be retrieved and stored in the hotel's operational server, global operational server, or hotel brand guest loyalty system. Additional, such operational services can provide both hotel brand, hotel and guest access to setting and preferences, which are received by the IGCC during configuration and check-in.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of an electronic device used to run an application providing access to a server in order for a guest at a hotel to perform travel related tasks.

FIG. 2 shows a schematic functional block diagram of the preferred embodiment of the Integrated Guest Communication Center showing its components.

FIG. 3 is a block diagram showing the preferred embodiment of the environment in which the IGCC can be used and illustrates a number of the functions it can be put to.

FIG. 4 is a computer generated mockup of two possible configurations of the IGCC case and display.

FIG. 5 is a depiction of the screen of the IGCC and a chart of the functions of the buttons pertaining to a particular mode of the software.

FIG. 6 is a depiction of the screen of the IGCC and a chart of the functions of the buttons pertaining to a particular mode of the software.

FIG. 7 is a depiction of the screen of the IGCC and a chart of the functions of the buttons pertaining to a particular mode of the software.

FIG. 8 is a depiction of the screen of the IGCC and a chart of the functions of the buttons pertaining to a particular mode of the software.

FIG. 9 is a depiction of the screen of the IGCC and a chart of the functions of the buttons pertaining to a particular mode of the software.

FIG. 10 is a depiction of the screen of the IGCC and a chart of the functions of the buttons pertaining to a particular mode of the software.

FIG. 11 is a depiction of the screen of the IGCC and a chart of the functions of the buttons pertaining to a particular mode of the software.

FIG. 12 is a depiction of the screen of the IGCC and a chart of the functions of the buttons pertaining to a particular mode of the software.

FIG. 13 is a depiction of the screen of the IGCC and a chart of the functions of the buttons pertaining to a particular mode of the software.

FIG. 14 is a depiction of the screen of the IGCC and a chart of the functions of the buttons pertaining to a particular mode of the software.

FIG. 15 is a depiction of the screen of the IGCC and a chart of the functions of the buttons pertaining to a particular mode of the software.

FIG. 16 is a depiction of the screen of the IGCC and a chart of the functions of the buttons pertaining to a particular mode of the software.

FIG. 17 is a depiction of the screen of the IGCC and a chart of the functions of the buttons pertaining to a particular mode of the software.

FIG. 18 is a depiction of the screen of the IGCC and a chart of the functions of the buttons pertaining to a particular mode of the software.

FIG. 19 is a depiction of the screen of the IGCC and a chart of the functions of the buttons pertaining to a particular mode of the software.

FIG. 20 is a depiction of the screen of the IGCC and a chart of the functions of the buttons pertaining to a particular mode of the software.

FIG. 21 is a depiction of the screen of the IGCC and a chart of the functions of the buttons pertaining to a particular mode of the software.

FIG. 22 is a depiction of the screen of the IGCC and a chart of the functions of the buttons pertaining to a particular mode of the software.

FIG. 23 is a depiction of the screen of the IGCC and a chart of the functions of the buttons pertaining to a particular mode of the software.

FIG. 24 is a depiction of the screen of the IGCC and a chart of the functions of the buttons pertaining to a particular mode of the software.

FIG. 25 is a depiction of the screen of the IGCC and a chart of the functions of the buttons pertaining to a particular mode of the software.

FIG. 26 is a depiction of the screen of the IGCC and a chart of the functions of the buttons pertaining to a particular mode of the software.

FIG. 27 is a depiction of the screen of the IGCC and a chart of the functions of the buttons pertaining to a particular mode of the software.

FIG. 28 is a depiction of the screen of the IGCC and a chart of the functions of the buttons pertaining to a particular mode of the software.

FIG. 29 is a depiction of the screen of the IGCC and a chart of the functions of the buttons pertaining to a particular mode of the software.

FIG. 30 is a depiction of the screen of the IGCC and a chart of the functions of the buttons pertaining to a particular mode of the software.

FIG. 31 is a depiction of the screen of the IGCC and a chart of the functions of the buttons pertaining to a particular mode of the software.

FIG. 32 is a depiction of the screen of the IGCC and a chart of the functions of the buttons pertaining to a particular mode of the software.

FIG. 33 is a depiction of the screen of the IGCC and a chart of the functions of the buttons pertaining to a particular mode of the software.

FIG. 34 is a depiction of the screen of the IGCC and a chart of the functions of the buttons pertaining to a particular mode of the software.

FIG. 35 is a depiction of the screen of the IGCC and a chart of the functions of the buttons pertaining to a particular mode of the software.

FIG. 36 is a depiction of the screen of the IGCC and a chart of the functions of the buttons pertaining to a particular mode of the software.

FIG. 37 is a depiction of the screen of the IGCC and a chart of the functions of the buttons pertaining to a particular mode of the software.

FIG. 38 is a depiction of the screen of the IGCC and a chart of the functions of the buttons pertaining to a particular mode of the software.

FIG. 39 is a depiction of the screen of the IGCC and a chart of the functions of the buttons pertaining to a particular mode of the software.

FIG. 40 is a depiction of the screen of the IGCC and a chart of the functions of the buttons pertaining to a particular mode of the software.

FIG. 41 is a depiction of the screen of the IGCC and a chart of the functions of the buttons pertaining to a particular mode of the software.

FIG. 42 is a depiction of the screen of the IGCC and a chart of the functions of the buttons pertaining to a particular mode of the software.

FIG. 43 is a depiction of the screen of the IGCC and a chart of the functions of the buttons pertaining to a particular mode of the software.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this detailed description section.

It will be apparent to those of ordinary skill in the art that although the systems and methods of this invention are often embodied in this description as applying to hotels, hotel rooms, and hotel guests, that the same systems and methods can be applied to other fields as well, and that the use in this document of these terms is used for simplicity rather than as a limitation of the scope of the invention. For instance the guest communication center herein described is an invention not just for hotels but for any facility, such as homes, condominiums, apartment complexes, cruise ships, office buildings, dormitories, airplanes, spacecraft or other structures or businesses. Likewise, all of the devices, methods, and systems herein described can be used for any of these businesses and locations as well. Therefore the terms hotel, hotel room, and guest should not be read as limiting the scope of this invention to the hospitality industry.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” “electronic device” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Near Field Communications (NFC) link, Local Area Network (LAN), Wide Area Network (WAN), Bluetooth, or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, Wi-Fi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

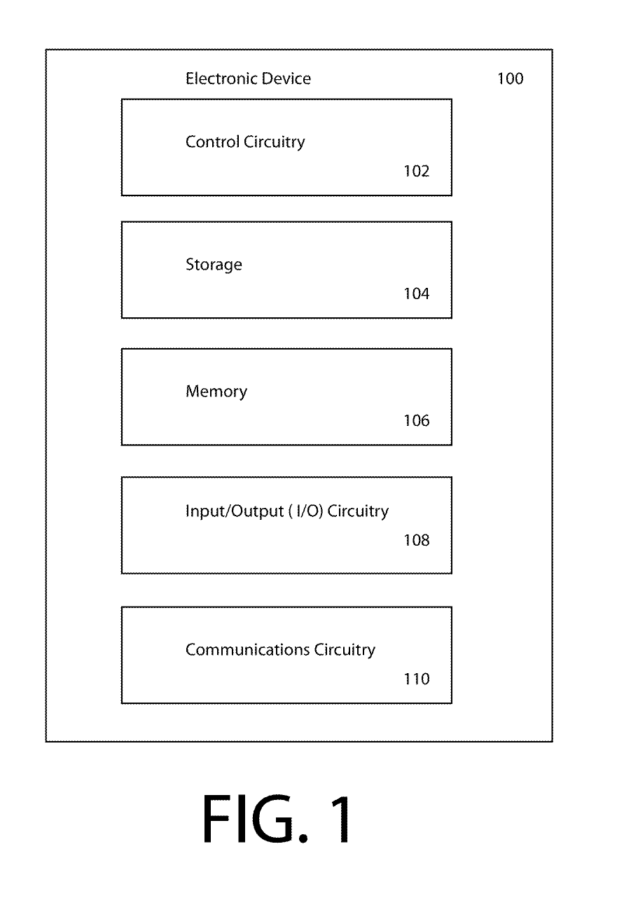

FIG. 1 is a schematic view of an illustrative electronic device for providing an application operative to interface with a hotel system in accordance with some embodiments of the invention. Electronic device 100 can include control circuitry 102, storage 104, memory 106, I/O circuitry 108, and communications circuitry 110. In some embodiments, one or more of the components of electronic device 100 can be combined or omitted. In some embodiments, electronic device 100 can include other components not combined or included in those shown in FIG. 1 (e.g., motion detection components, a power supply such as a battery or kinetics, a display, a bus, a positioning system. or an input mechanism), or several instances of the components shown in FIG. 1. For the sake of simplicity, only one of each of the components is shown in FIG. 1.

Electronic device 100 can include any suitable type of electronic device. For example, electronic device 100 can include a portable electronic device that the user may hold in his or her hand, such as a digital media player, a personal e-mail device, a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer or a docking station.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface.

Storage 104 can include, for example. one or more storage mediums including a hard-drive, solid state drive, flash memory, permanent memory such as ROM, any other suitable type of storage component, or any combination thereof. Storage 104 can store, for example, media data (e.g., music and video files), application data (e.g., for implementing functions on electronic device 100), firmware, user preference information data (e.g., media playback preferences), authentication information (e.g. libraries of data associated with authorized users), lifestyle information data (e.g., food preferences. exercise information data (e.g., information obtained by exercise monitoring equipment), transaction information data (e.g., information such as credit card information), wireless connection information data (e.g., information that can enable electronic device 100 to establish a wireless connection), subscription information data (e.g. information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM and/or one or more different types of memory used for temporally storing data. In some embodiments, memory 106 can also be used for storing data used to operate electronic device applications, or any other type of data that can be stored in storage 104. In some embodiments, memory 106 and storage 104 can be combined as a single storage medium.

I/O Circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive or resistive sensing mechanic, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within electronic device 100) can include video Codecs, audio Codecs, or any other suitable type of Codec.

In some embodiments, I/O circuitry 108 can include display circuitry (e.g., a screen or projection system) for providing a display touchable by the user that allows for tactile input to control the device and functions.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, L4 GHz, and 5.6 GHz communication systems), infrared, GSM, GSM plus EDGE, CDMA, quadband, and other cellular protocols, VOW, Near Field Communications (NFC), or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one or more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled to a host device for data transfers, synching the communications device, software or firmware updates, providing performance information to a remote source (e.g., providing riding characteristics to a remove server) or performing any other suitable operation that can require electronic device 100 to be coupled to a host device. Several electronic devices 100 can be coupled to a single host device using the host device as a server. Alternatively or additionally, electronic device 100 can be coupled to several host devices (e.g., for each of the plurality of the host devices to serve as a backup for data stored in electronic device 100).

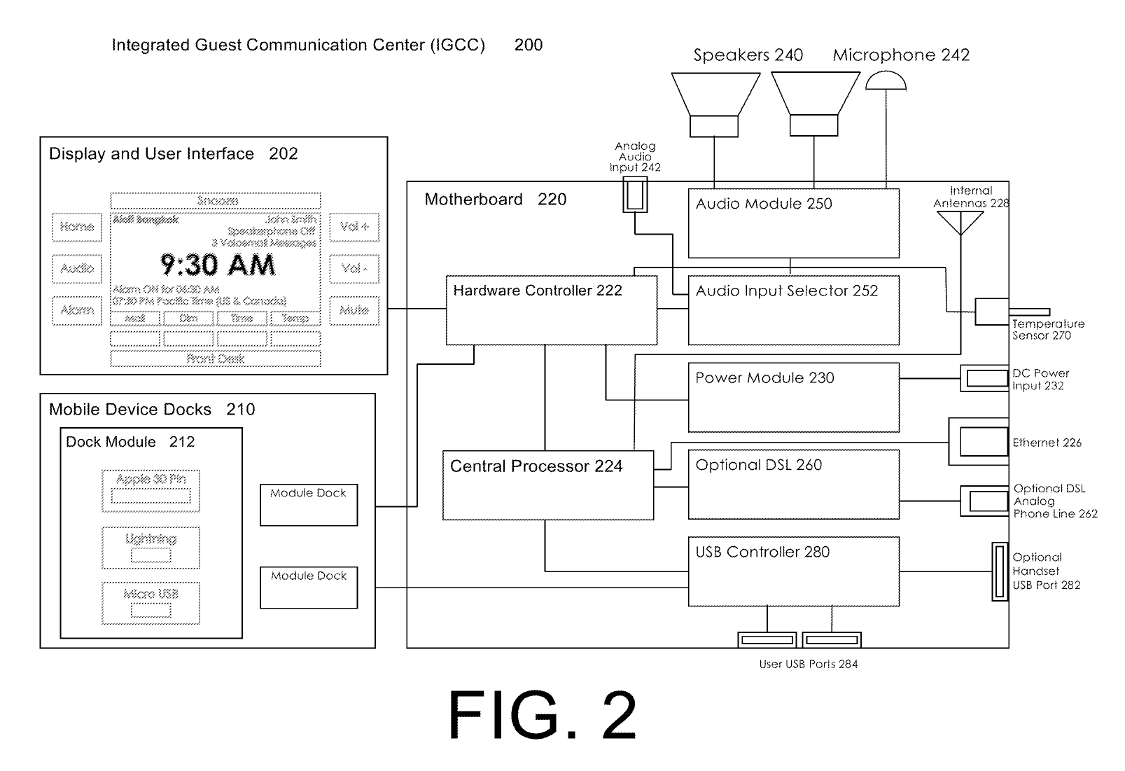

FIG. 2 is a block diagram of the preferred embodiment of the IGCC. For purpose of illustration the device is shown in a configuration having a display and user interface 200, mobile device docks 210, and a motherboard 220, each of these systems comprising several other components and with a number of additional components attached to these main systems. This illustration is merely a preferred embodiment, and a number of embodiments are contemplated, some of which will be mentioned as possible changes or additions to this preferred embodiment.

The device shown in FIG. 2 is an electronic device incorporating, incorporating the components of the generic electronic device in FIG. 1, however in FIG. 2 the components have been arranged and have had additional components added to operate as an Integrated Guest Communication Center (IGCC) 200. The purpose of the IGCC is to perform many of the functions performed by current discrete devices used by a hotel guest or the hotel operators, including a room phone, thermostat, alarm clock radio, portable electronics dock, etc., as well as to operate as a wireless access point. It should be clear to one ordinarily skilled in the art that not all components of the device are illustrated here, but will be obvious when constructing the device

The preferred embodiment of the IGCC 200 allows interaction by a user by means of a display and user interface 202. The display can be composed of an electroluminescence screen, LCD screen, an OLED screen, or by any other display type which allows words to be read by the user. In the preferred embodiment, the screen is a 3.5″ TFT LCD screen. In the preferred embodiment the screen may be interacted with by the user through buttons next to and/or below the screen with individual functions as well as by one or more “soft keys” which will have different functions based on the context in which they are used, and this function can be displayed on the screen. In the preferred embodiment, dedicated labeled buttons are arranged around the screen, while four non-labeled buttons are located directly below the screen to act as “soft” buttons which are selected by the guest according to labels displayed on the screen directly above these soft buttons. In other embodiments, the user could interact with the device by other means of input, such as a touch screen, voice control, a keyboard and mouse, a number pad, or any other input means. The specific modes and functions of the display will be detailed later in this document.

The IGCC 200 in the preferred embodiment is based on a motherboard having the basic components of an electronic device as described in FIG. 1 and described above. The electronic functions of the device are processed by a central processor 224, which can be any appropriate microprocessor, or by more than one processing unit. In the preferred embodiment, the CPU is part of a Carambola™ Linux processor board from www.8devices.com. The central processor 224 is attached by an appropriate circuit to a hardware controller 222, which performs many or all of the input/output functions of the device. Together, the central processor 334 and hardware controller 222 direct and control the remaining components of the IGCC 200, and while FIG. 2 shows the connection of individual components to either the hardware controller 222 and 224, the individual connections will vary and will not need to be as shown in FIG. 2, as long as they are connected in such a way as to perform the functions of the preferred embodiment of the IGCC 200.

In the preferred embodiment of the IGCC, the hardware controller 222 and central processor 224 run on a Linux operating system using code stored in attached flash memory which will also store device firmware. In other embodiments, other appropriate memory storage means may be used, as well as other operating systems.

The preferred embodiment of the IGCC 200 has mobile device docks 210, containing one or more dock modules 212. These dock modules connected to the IGCC via a USB type connection or any other appropriate connection means capable of interfacing with a portable electronic device. Additionally, these modules, in the preferred embodiment, are modular, meaning that they can be interchanged during their manufacture or at a later date. In this way, the IGCC can be updated and upgraded to newer connective means as needed. For instance, if a hotel is purchasing the device, they might customize the device by having it incorporate an Apple® 30-Pin connector for fifth generation iPhones® and with a micro USB connector for Android® phones. At a later date they would be able to upgrade the device to, for instance, an Apple Lightning® port, to accommodate newer Apple iPhones®, iPods® and iPads®. Since the connection is modular and may be based on industry standard USB connections, even connectors not yet contrived may be incorporated as they become available. The dock modules connect to the mother board by a none-device specific bus.

In addition to the specific dock connectors in the mobile device docks 210, the IGCC 200 in the preferred embodiment incorporates one or more user accessible USB ports 284. The USB standard used can be any appropriate standard, such as USB 2.0 or 3.0 or a future standard. In other embodiments, the device may contain ports serving a similar purpose to the USB ports contemplated here, such as a Firewire® port or an Apple Thunderbolt® port.

Both the mobile device docks 210 and the User USB ports 284 serve a number of purposes. One purpose the two components have in common is that either can be used to charge an appropriate mobile device such as a media player or mobile phone. The mobile device docks 210 can deliver power from the IGCC 200 through the connector chosen, and the User USB ports can deliver the standard 5 volt power at sufficient amperage to power standard electronic devices which are normally powered with USB connections.

In addition to power, both the dock module 212 and the user USB ports 284 are capable of facilitating a data connection between the IGCC 200 and an appropriate user device. In the preferred embodiment, the hardware controller 222 and/or USB controller 280 will be capable of communicating with specific devices via the use of appropriate drivers. For instance the IGCC 200 in the preferred embodiment, can communicate with an iPhone® through an appropriate dock module or through the User USB ports by means of an appropriate connection cable. The drivers may be capable of interacting with such a device in any way which the driver and the device allows, for instance it may be able to play music from the attached device over the speakers 240 built into the device.

The preferred embodiment of the IGCC 200 also includes an optional handset USB Port 282, which is supplied for the purpose of attaching a corded USB phone handset to the device, which are widely available, thus augmenting the phone functions of the IGCC by supplying a handset providing its own audio input and output as well as a keypad which may be used to dial numbers. In the preferred embodiment, the IGCC is capable of performing many phone functions both with and without a USB handset, which will be described further later in the document.

The IGCC 200, in the preferred embodiment, is powered by a means of a connected DC power input from, for instance, a wall plug DC converter which can be attached to the DC power input 232, supplying power to a Power module 230, which supplies appropriate voltages to the hardware controller 222, which further distributes power to the components of the IGCC. In other embodiments, some of these components may receive power directly from the power module 230 or may have some other independent power source or module. In an alternate embodiment, if connected to a wired Ethernet connection that provides power-over-Ethernet (POE), the device could use such a power connection, and forego the use of an AC power adapter. Alternately, a suitable power supply located within the IGCC could take available AC (110 v to 240 v) and convert it into the low voltage need for the devices inside.

In the preferred embodiment, the IGCC 200 connects to a network and/or the internet by one of several included means. The IGCC 200 can accept an Ethernet connection via the Ethernet 226 port. Alternatively, the device may contain an optional DSL module 260 and an optional DSL analog phone line connector 262 in order to obtain a network connection. Additionally, the preferred embodiment contains one or more internal antennas 228, which may include one or more Wi-Fi antennas capable of making a network connection. If the internet is received in any of the three ways above, the preferred embodiment of the IGCC 200 will be able to use one or more Wi-Fi antennas to create a local Wi-Fi access point through which other devices within range may connect to receive network and internet access.

The internal antennas 228 may include receivers for other wireless standards as well, such as Bluetooth® or NFC® or a Wi-Fi based standard and can use these to connect to devices in much the same way as the USB connections earlier, performing functions and communicating with connected devices to the extent allowed by the installed device drivers. Additionally, where needed, external Wi-Fi antennas may be attached to the IGCC to extend its range.

The IGCC 200 in the preferred embodiment contains an audio system composed of a number of individual components. The audio input selector 252 connects to the hardware controller 222 and is responsible for connecting to the various audio input sources and determining which ones to send to the audio module 250. The audio input selector can receive inputs from the hardware controller originating from any of the subsystems capable of outputting an audio signal. For instance, in its function as a IP phone, the IGCC 200 can output a phone audio signal to the selector, or when a music source is supplied by the IGCC 200 or an attached device, that signal as well can be sent to the selector. The preferred embodiment also contains a standard analog audio input 242 which is a 3.5 mm audio jack which can be attached via an appropriate cable to the headphone or other output jack of a number of portable electronic devices. One or more of these signals can then be sent to the audio module which contains an amplifier which sends the decoded audio signal to the speakers 242.

Using the audio selector and amplifier, the IGCC 200 can play audio content from either of the two dock ports located on the top of the IGCC 200, the various USB ports on the IGCC 200, the 3.5 mm audio jack on the IGCC, or audio files. Such audio files can be provided over the Internet, such as from the operational server connected to the IGCC 200. Additional audio content can come from Internet sources, such as internet radio stations.

In the preferred embodiment, the IGCC 200 also has a microphone 242 which is capable of inputting audio to the device to serve functions such as an input for a speakerphone function. In some embodiments, the microphone also serves as the input for voice control of the system. In such an embodiment, the voice control software can either be installed on IGCC 200 directly, or can be handled through network connectivity on a remote server by sending the voice recording of the user and receiving back a command based on the server software's interpretation of the users verbal command

The preferred embodiment of the IGCC 200 includes one or more temperature sensors 270 which will be capable of determining the ambient room temperature in order to serve as a thermostat for a temperature control unit which is networked or attached to the IGCC 200 through an appropriate means. In some embodiments, the temperature sensor 270 may be calibrated to take into account the ambient heat generated by the IGCC 200 or may calibrate on the fly using more than one temperature sensor 270 in concert. If there is a networked temperature unit in the room, the IGCC 200 may also take into account the temperature that device reports in determining the actual room temperature.

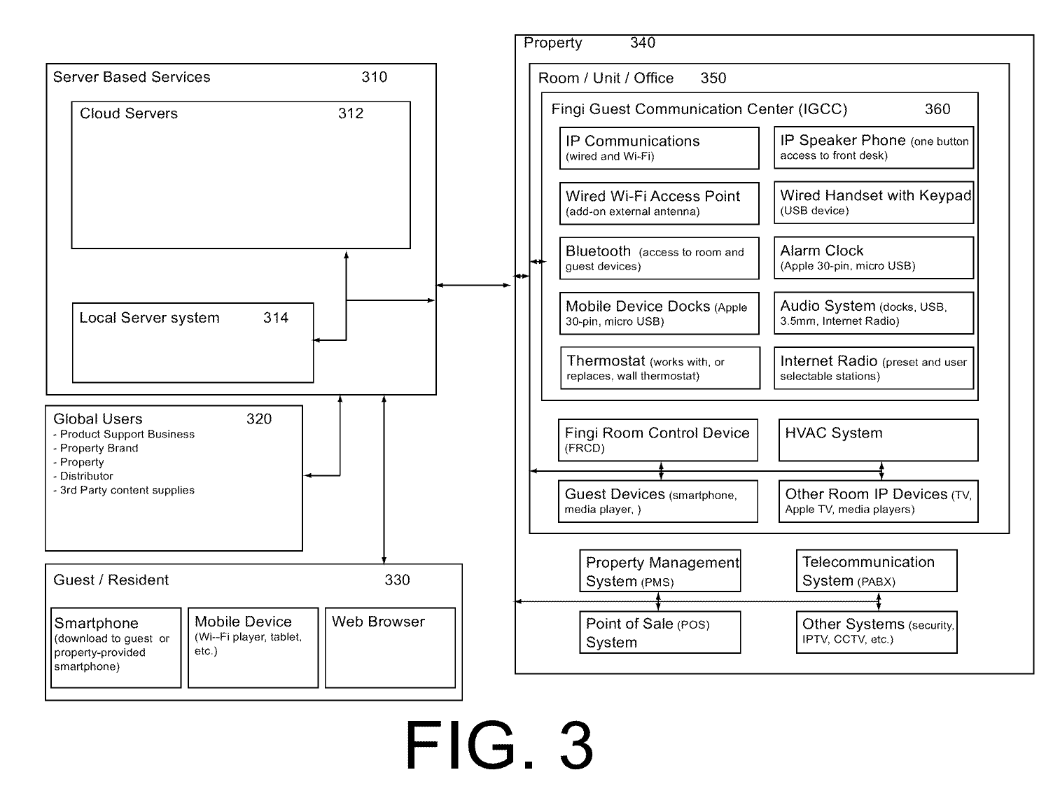

FIG. 3 is a block diagram showing the preferred embodiment of the environment in which the IGCC 360 can be used and illustrates a number of the functions it can be put to.

The IGCC 360 box in FIG. 3 shows ten of the uses to which the IGCC can be put, each of which has been explained elsewhere in this detail description.

In some embodiments, through a network connection, the IGCC 360 can also communicate with various networked or attached devices in a room/unit/office 350. This includes any networked appliance or devices in room, such as any entertainment devices, as well as other devices which can be converted to network with available networked appliance control devices, which can be attached to a number of appliances such as thermostats, lights, televisions, etc. Using the Bluetooth connection within the IGCC 360, various mobile and in-room devices, such as smartphones, tablet computers, laptop computer, music players, media players, televisions, etc. may be interactively connected to the IGCC.

In some embodiments, the network connection also allows the IGCC 360 to communicate with the other networked devices on a property 340, such as a hotel's property management system (PMS), telephone system (PABX), point of sale (POS) system, reservations system, loyalty system, and other systems. This connection allows the IGCC 360 to perform functions such as placing and receiving phone calls, making purchases, or allowing a guest to check their bill for the hotel stay or receive other information such as check out times. Further this connection also can allow user to save IGCC settings to an integrated loyalty system or other system profile.

In some embodiments, the IGCC 360 is connected to a server system 310 through a direct network connection, such as an Ethernet connection to an onsite local server 314, or via an internet connection to an on-site or cloud based server 312. This connection allows a number of global users to interact with a particular IGCC 360 or many IGCCs. For instance, a Product Support business may use this connection to push updates to the IGCC 360 through the server system, allowing the software and firmware to be updates. This allows the device to be altered or have bugs removed remotely, or even to push updates such as new device drivers for portable electronic devices that come out after the IGCC 360 has been made.

This server connection also allows property brands such as a hotel chain, or property manager, such as the manager of a particular hotel, to modify or update the device remotely. In some embodiments, the device is also capable of relaying certain information, such as its working state, or data about the use the guest has put it to. Such guest data is valuable to the businesses that have set up the IGCCs. Error reports from the device can also be obtained remotely, notifying and allowing the property managers, or even the device distributors to perform maintenance on a malfunctioning device.

In some embodiments, the guest too, may use the network to communicate with the device, in addition to direct interaction described earlier. For instance, the guest could use a smartphone, mobile internet device, or a web browser to communicate with the device to remotely set the temperature of the built in thermostat, or to set an alarm on the device.

In the preferred embodiment, the connection between the IGCC 360 and the cloud server 312 (which can also be a local hotel server 314) has a number of important functions. In the preferred embodiment, the cloud server 312 can send to the IGCC 360: firmware updates, operational software updates, driver updates, and changes to the GUI settings. The cloud server can also be used to send user specific information such as routing incoming phone calls, allowing voicemail access, sending caller ID information, and sending local Wi-Fi access point information.

In addition, in the preferred embodiment the cloud server 312 is used also to handle user specific information. Because the cloud server 312 has access to local PMS systems in a hotel, the cloud server will be able to identify the particular guest assigned to a room, and thus be able to perform various guest specific functions through the IGCC 360. The cloud server 312 and local server 310 will in some embodiments have a database of users and data pertaining to the individual users. If a user has used an IGCC 360 in the past, the cloud server 312 or local server 310 will have a record of their use and can identify key settings which the user had previously chosen, and can push those settings out to the IGCC 360. For instance if the user had on a previous stay had the temperature in the room set at 72 degrees, the cloud server 312 or local server 310, in the preferred embodiment, will have that information stored, and will be able to push that setting to the IGCC 360 when it has determined through the PMS system or some other means that the user has checked into a room, or even in anticipation of a check in by the user. Other settings which can be stored and retrieved in a similar fashion include: alarm time, do not disturb status (DND), make up room (MUR) status, desired fan speed, guest preferred temperature format, guest preferred time format, property preferred temperature format, property preferred time format, guest preferred second time zone, guest preferred Internet Radio Station, and maximum volume level.

In a similar fashion, the IGCC 360 can make requests to the server systems 310 to perform a number of functions in the preferred embodiment. Using IP telephony, the IGCC 360 may send a request to the server system 310 to place a call, to get the status of a Wi-Fi access point, to get DSL internet status, to set a do not disturb status for the room, to set a MUR status, set their preferences for the IGCC 360, to get internet radio lists, to receive internet radio signal, and to retrieve hotel or room information.

The IGCC 360 can automatically customize the language displayed by the device based on the guest's country of origin (from the PMS) or preferences stored by the IGCC operational server. Depending on whether there are language preferences stored in the hotel's PMS, the guest preferences in the server 310, or other sources, the IGCC 360 can preset the appropriate language upon check-in.

The IGCC 360 is interfaced with the hotel's telephone system, allowing the guest to have access to the voicemail system, both through audio and screen commands. In the voicemail mode, the IGCC 360 communicates with the server 310 voicemail system in the PABX, allowing the user to view information about their current voice mail messages, play messages, save messages, and delete messages.

Additionally, when operating in the telephone mode, the IGCC 360 can display a list of services that can be selected by the guest and dialed. The hotel can enter a list of phone directory items (name and number) to be displayed by the IGCC 360. This list could include the front desk, the concierge, room server, maid service, bell captain, car park, and any other hotel phone number. Additional, the guest's own phone numbers, such as their home and office numbers, that are stored in the PMS, or server 310, could be displayed. The hotel guest would select the desired number from the list displayed by the IGCC 360 and it would be dialed.

The hotel guest can select from a variety alarm types in the IGCC 360, including various alarm tones (steady tone, gradually increasing tone, etc.), audio sources (Internet radio, connected mobile devices, etc.), operate other in-room functions (open curtains, turn on television to selected channel, turn on lights, or combination, possibly stored as moods) through the operational server and connected room control systems. Such option would be selectable by the guest in the IGCC 360, but could be pre-selected, and/or retrieved from the server 310.

In the hotel setting, it is critical that guest's alarm requests are honored, so that a guest does not miss an important meeting or travel arrangements. When the hotel fails to wake a guest, they often have to provide some form of compensation, such a not charging for that night's stay. Because the IGCC 360 can monitor its audio sources, and possible the ambient sound in the room (using the built-in microphone), the IGCC 360 includes an alarm fail-safe system that makes sure that some sound is produced when the alarm is to sound. When the IGCC 360 activates the clock alarm, the IGCC 360 can monitor the audio output of the either the audio source selector or audio amplifier, to verify that sound is being produced at a minimum volume to wake the user. If this criteria is not being met by the current alarm source, the IGCC 360 will default to a known alarm type, such as a steady tone. Alternatively, or additionally, the IGCC 360 can use its internal microphone to actually monitor the sound level (but not the exact content—guest's do not want their conversations monitored) to assure that sufficient sound is being generated to wake the guest. In any event, if the guest fails to turn off the alarm in a timely manner, the IGCC 360, through the sever 310, can alert the front desk so that they can take additional measures, such as calling the room, or sending someone up to the room.

Additionally, snooze settings can be configured by the hotel—i.e. length of snooze time. Most current alarm clocks have a predetermined snooze time (such as sever minutes). Such settings can be retrieved as preferences stored in the hotel's operational server. The IGCC 360 also allows the guest to set the snooze ahead of the alarm being activated, but will also allow the guest to adjust the snooze time when the snooze is active.

Studies have shown that some people sleep better when their alarm clock is dimmed. The IGCC 360 allows the display to be dimed by the guest. However, when the alarm is activated, the screen returns to normal brightness. The dim setting can be stored as a guest preference in the server 310. The IGCC 360 also prevents the guest from dimming the screen to a level where the screen cannot be read by the guest.

The IGCC 360 is completely customizable by the hotel brand, hotel, including look and feel, logos, services names, etc. In the consumer version of the IGCC 360, the owner, through a web portal to server 310, can customize the look and feel, including choosing preset themes, such as Hello Kitty®.

Additionally, all guest preference can be retrieved and stored in the hotel's operational server 310, global operational server 310, or hotel brand guest loyalty system. Additional, such operational services can provide both hotel brand, hotel and guest access to setting and preferences, which are received by the IGCC 310 during configuration and check-in.

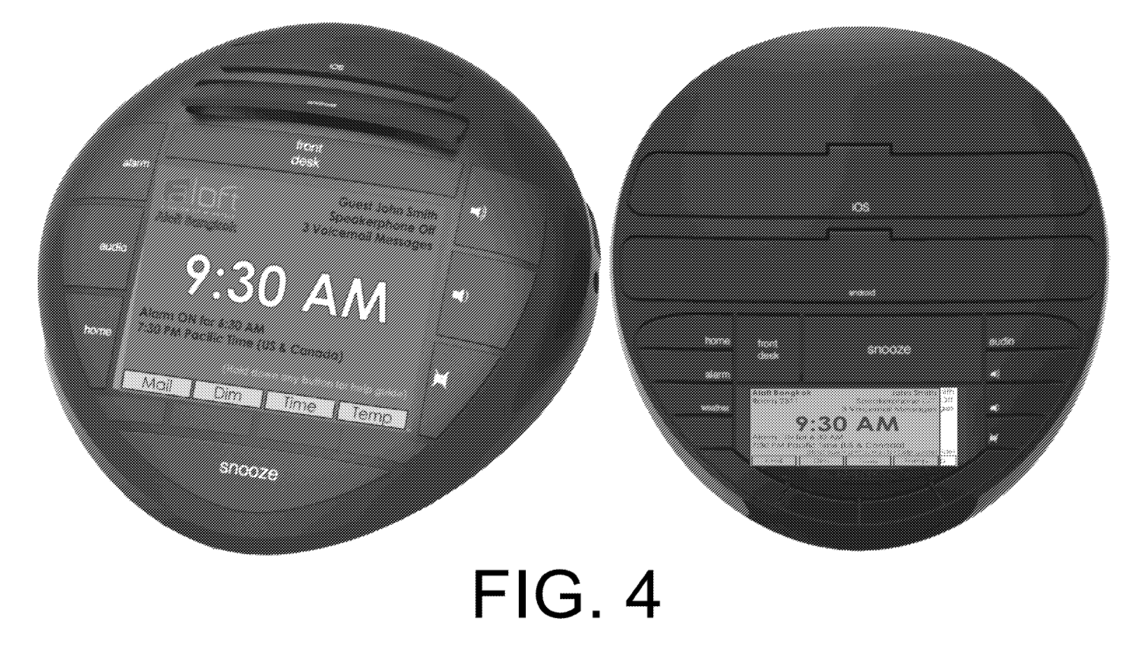

FIG. 4 is a computer generated illustration of two embodiments showing the case and screen of the IGCC, showing the placement of the screen and how the dock modules might look in a vertical configuration.

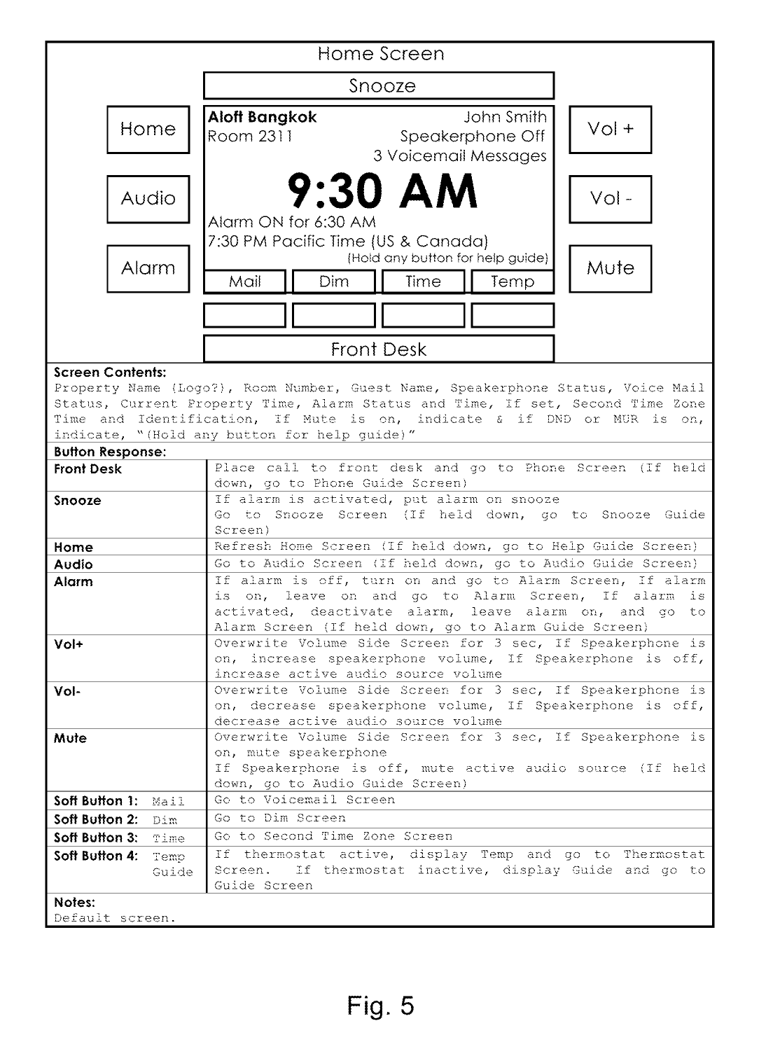

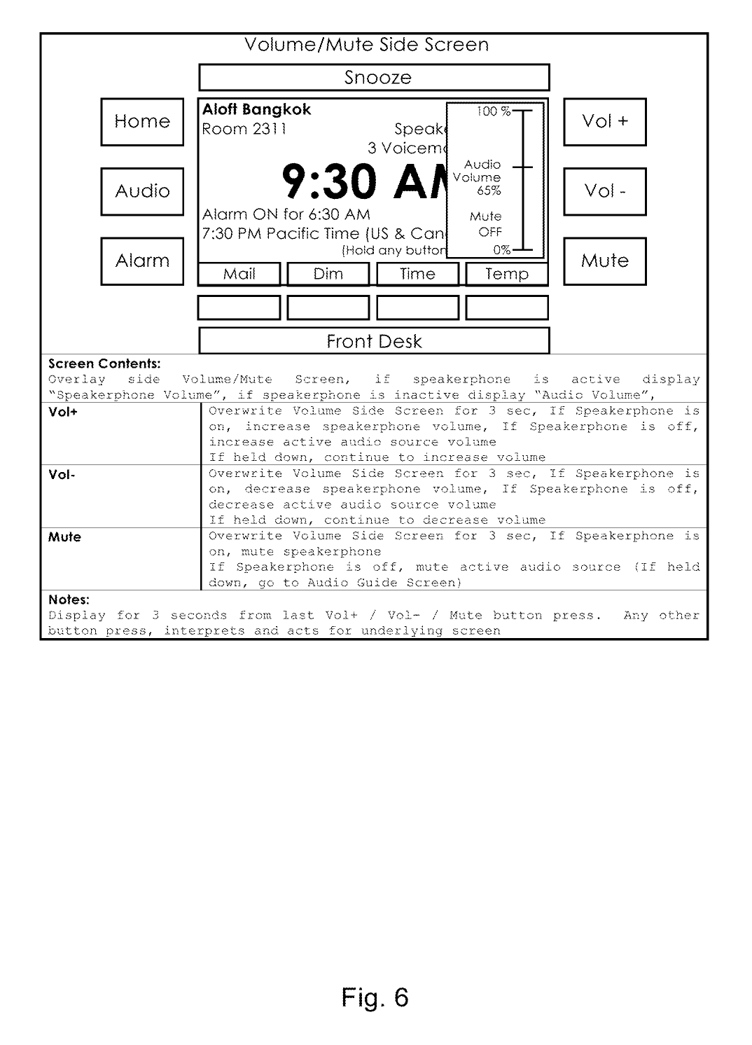

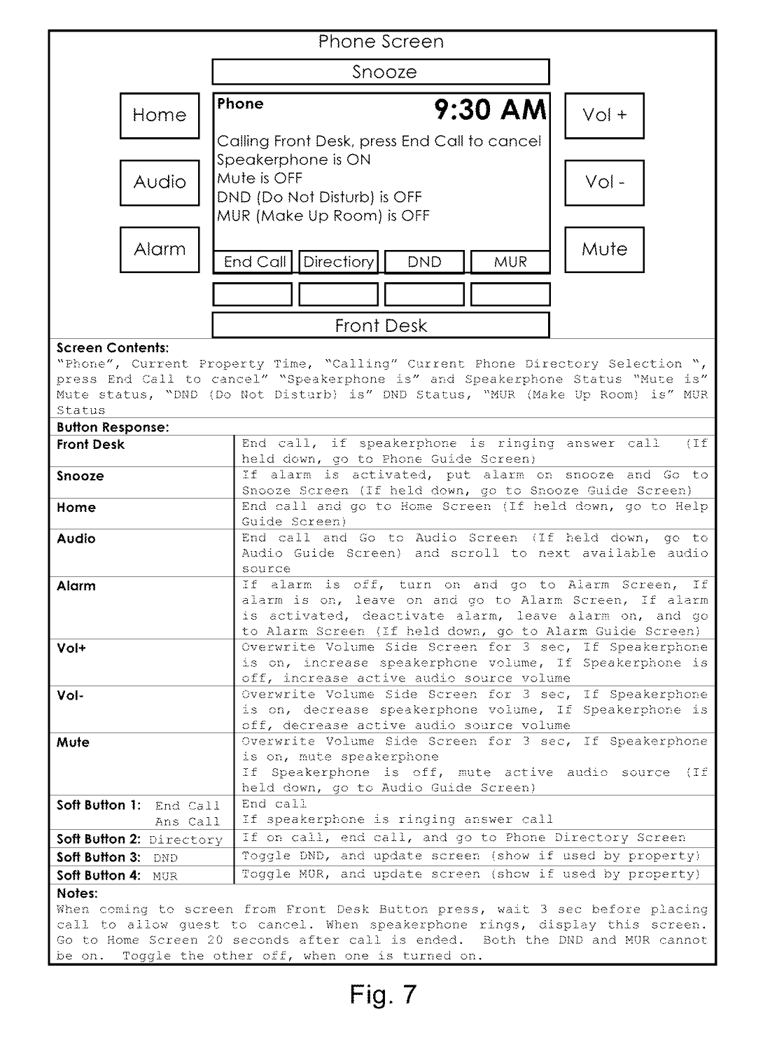

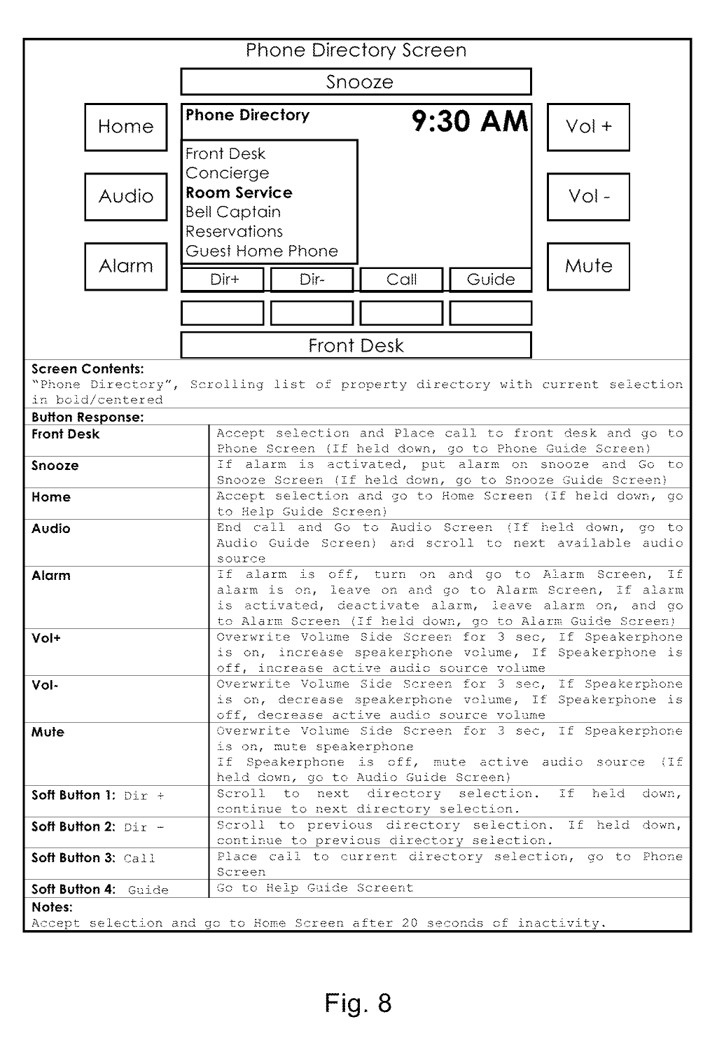

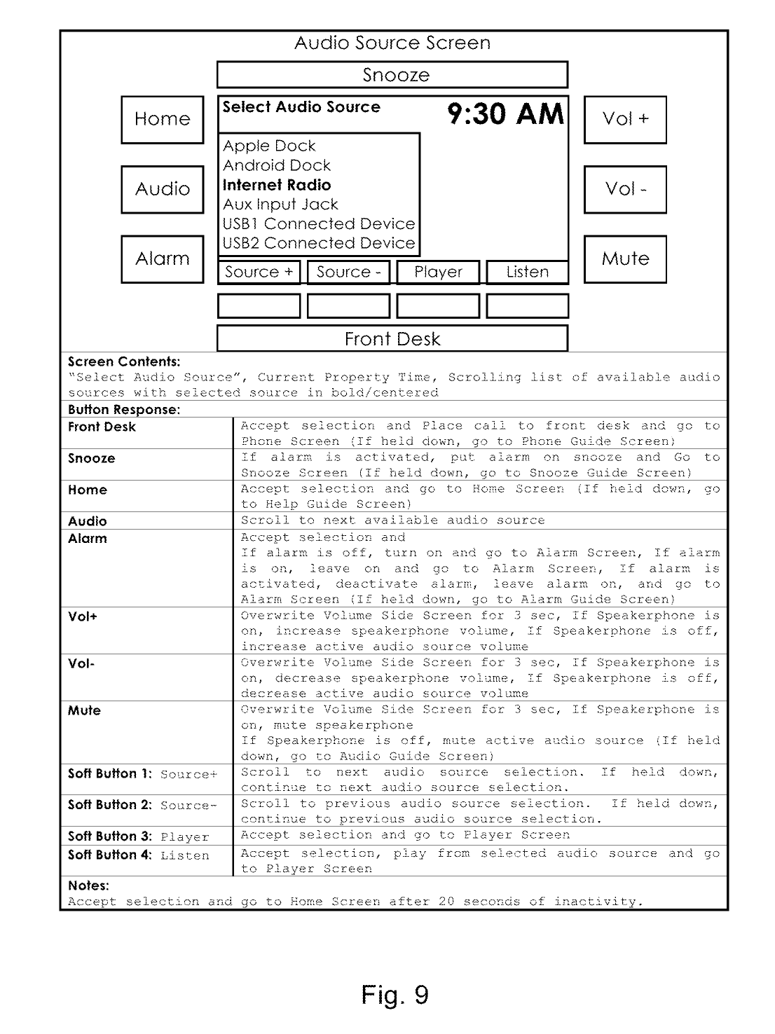

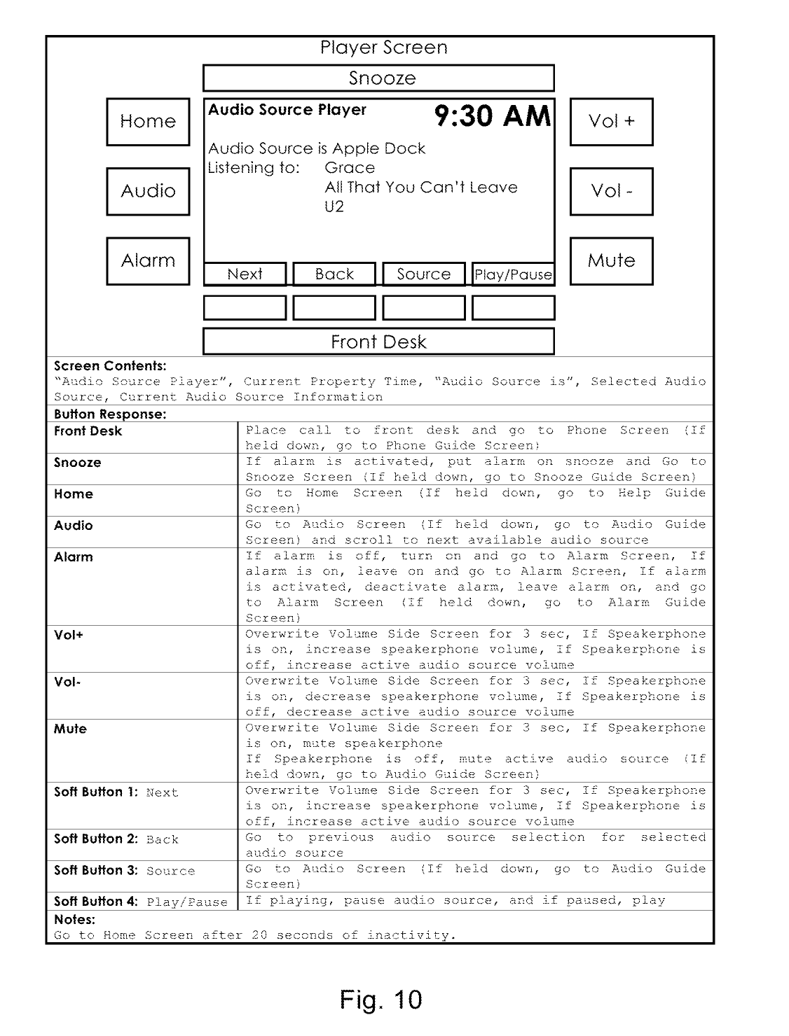

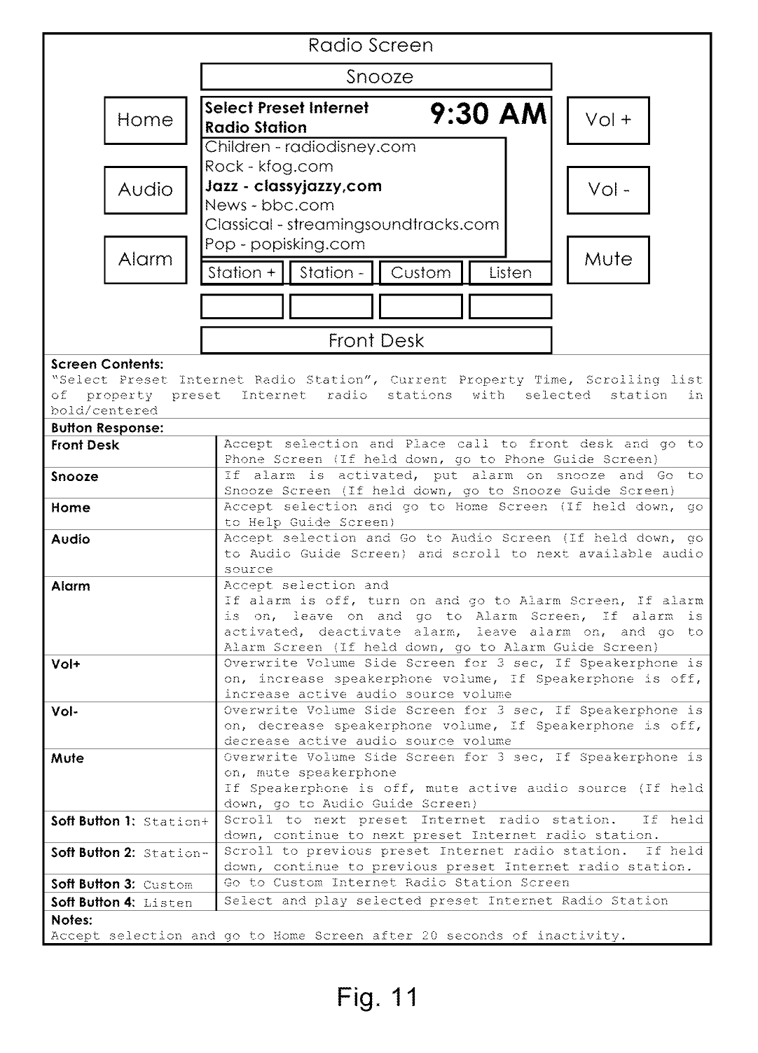

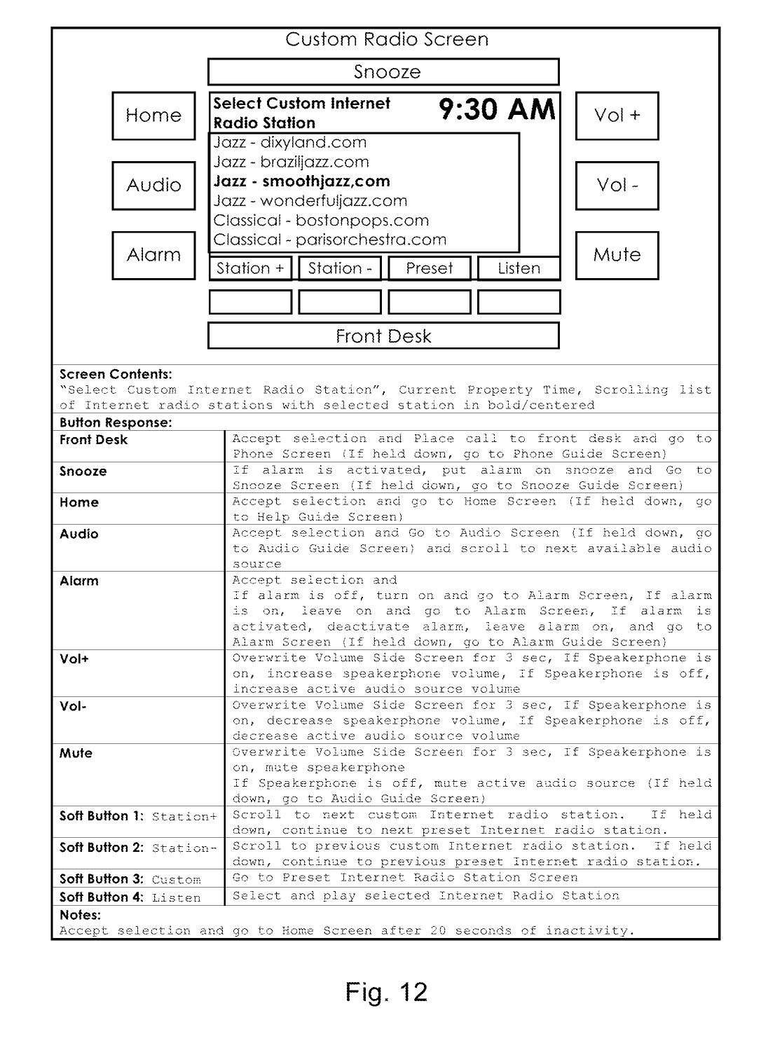

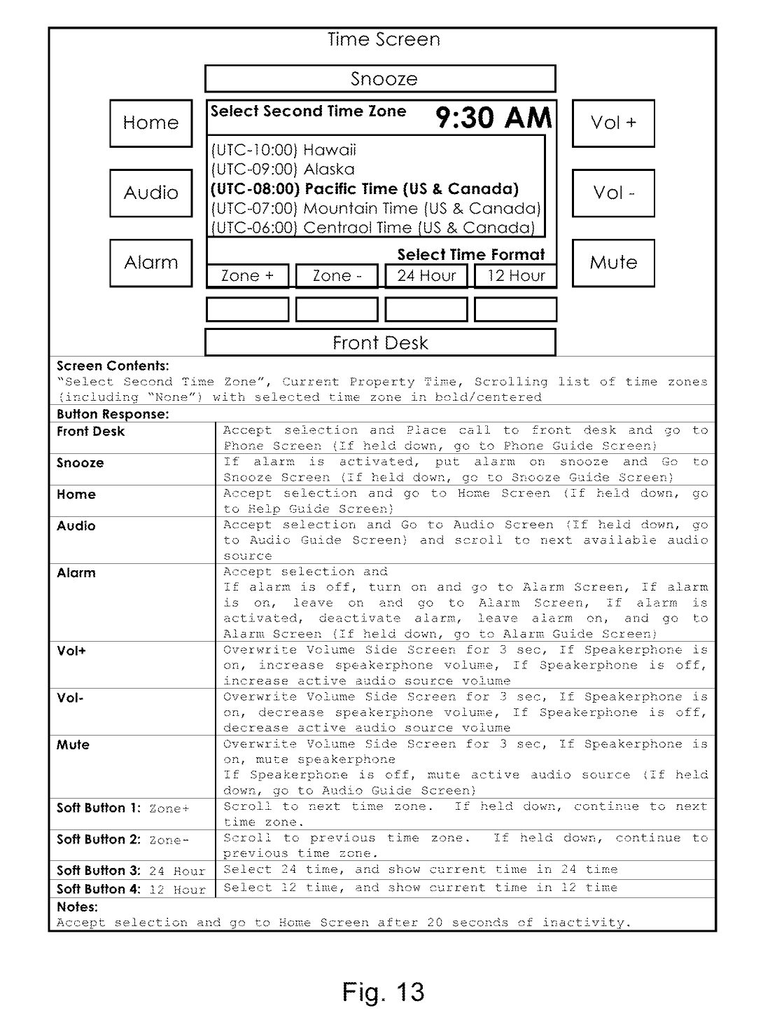

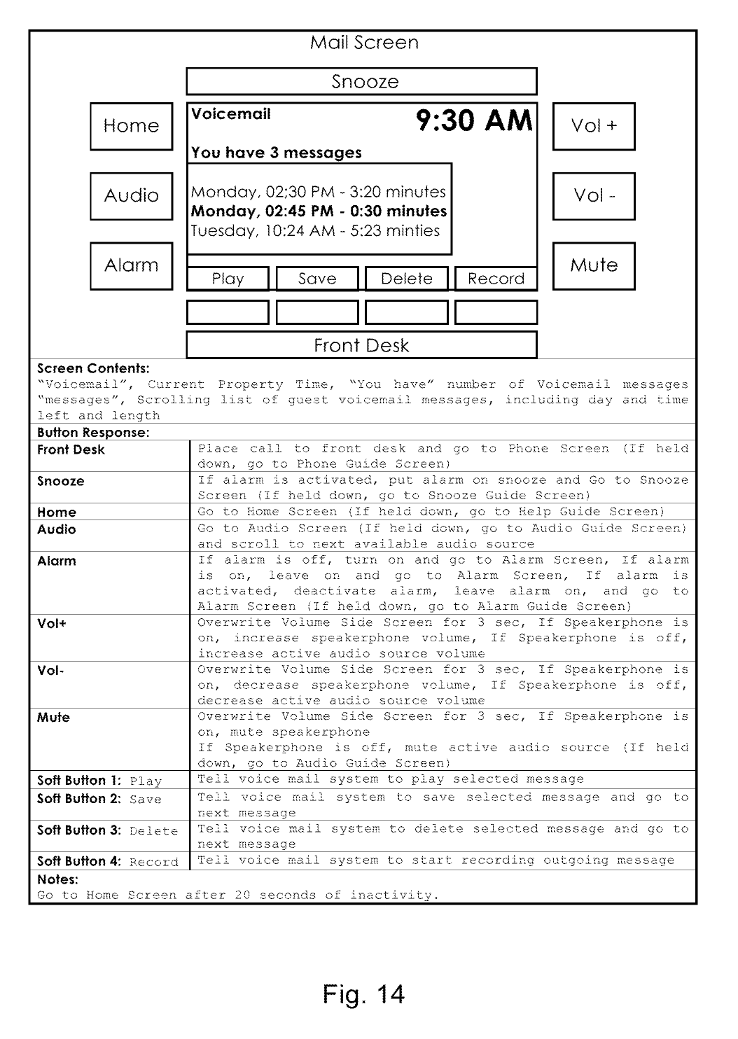

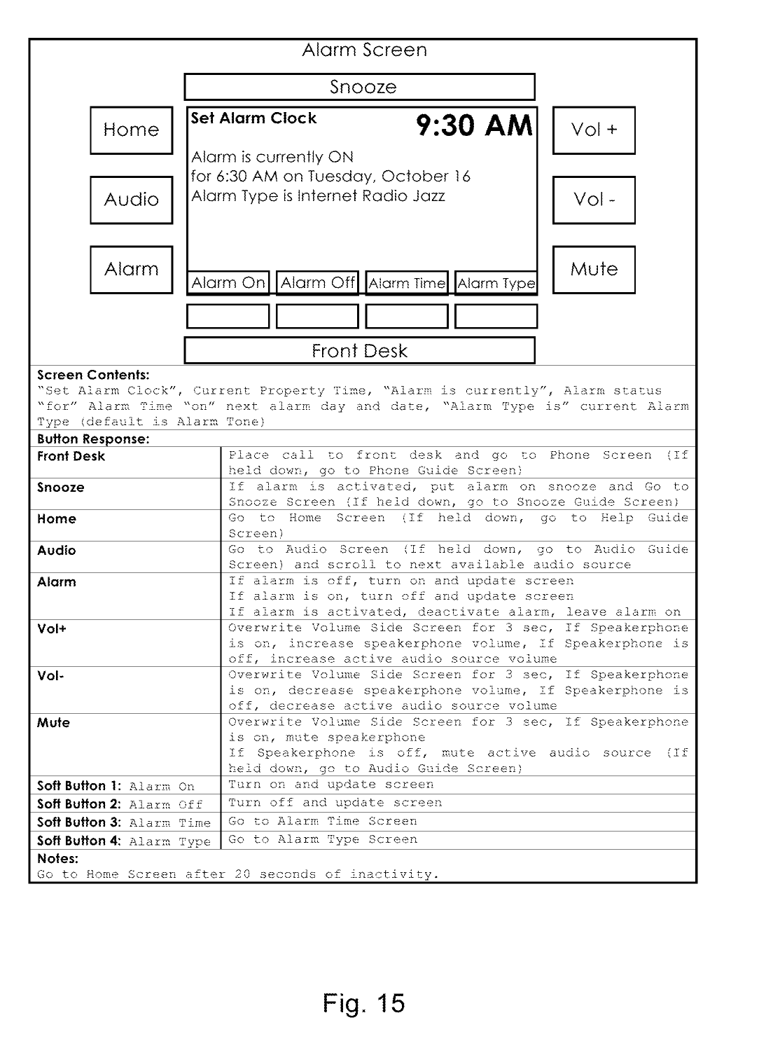

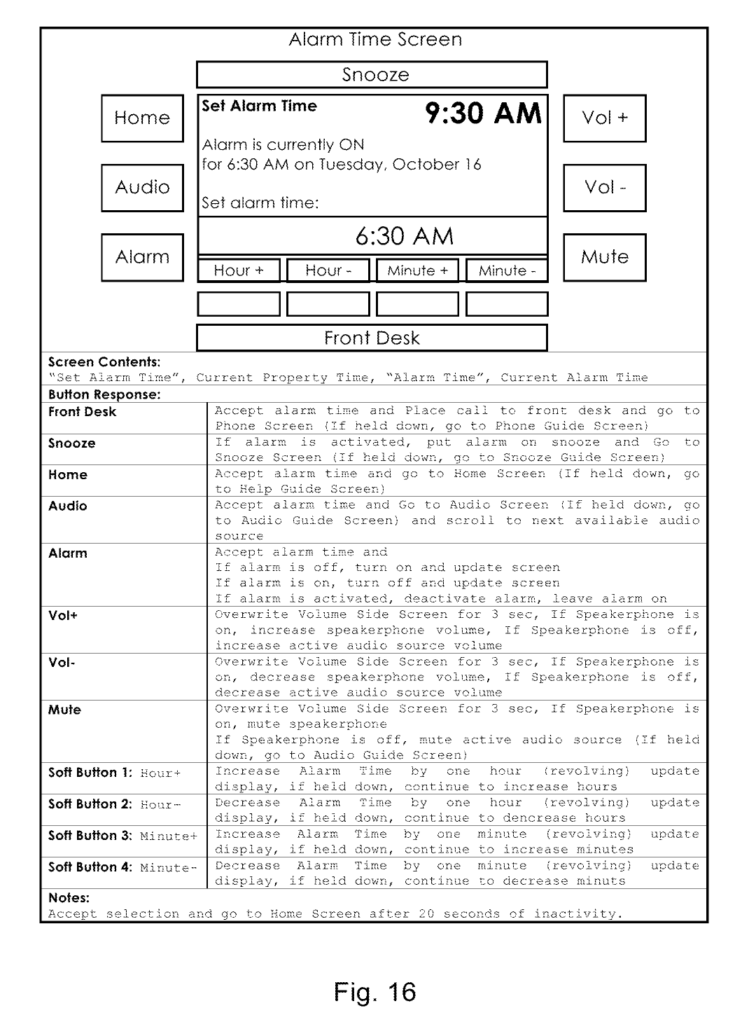

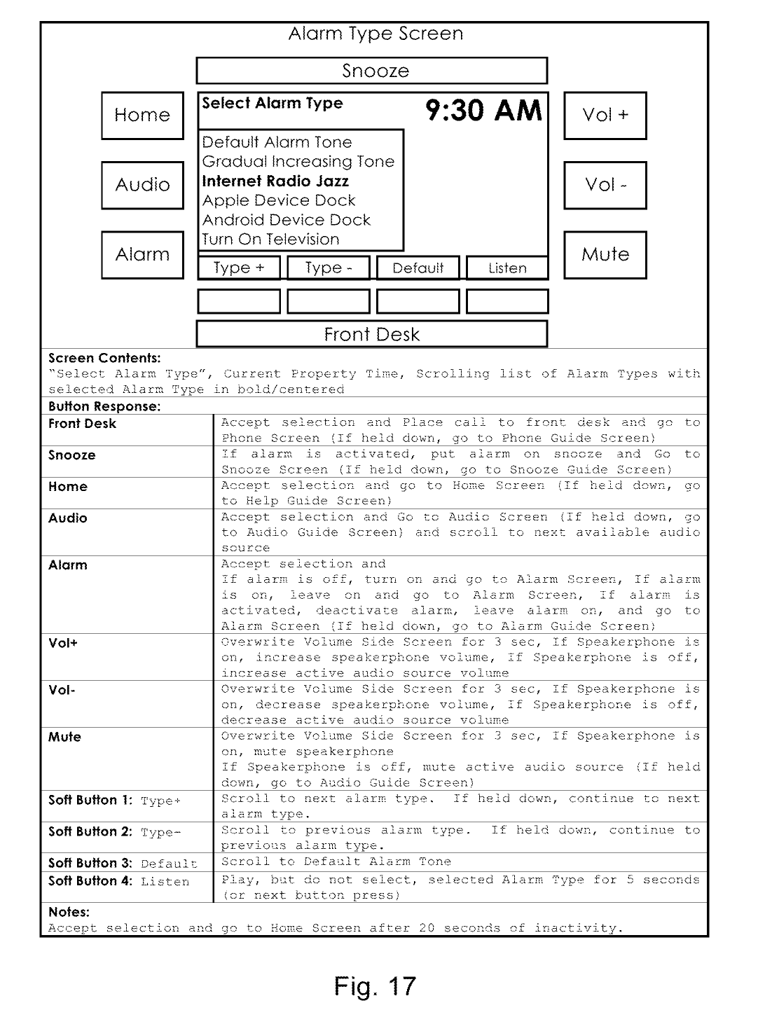

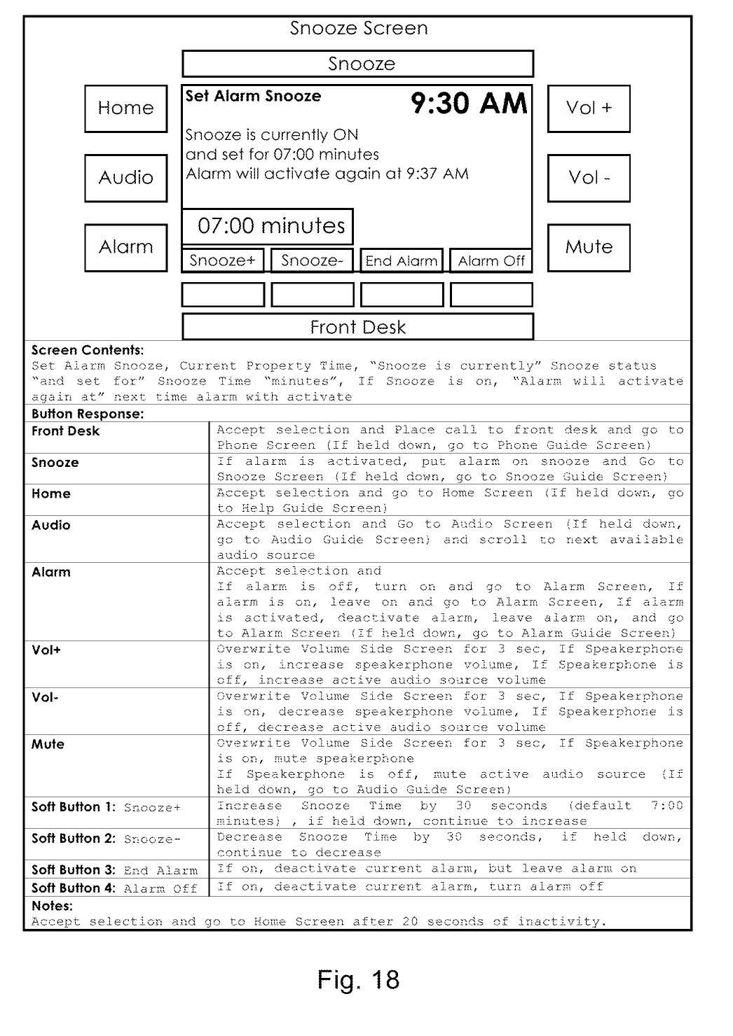

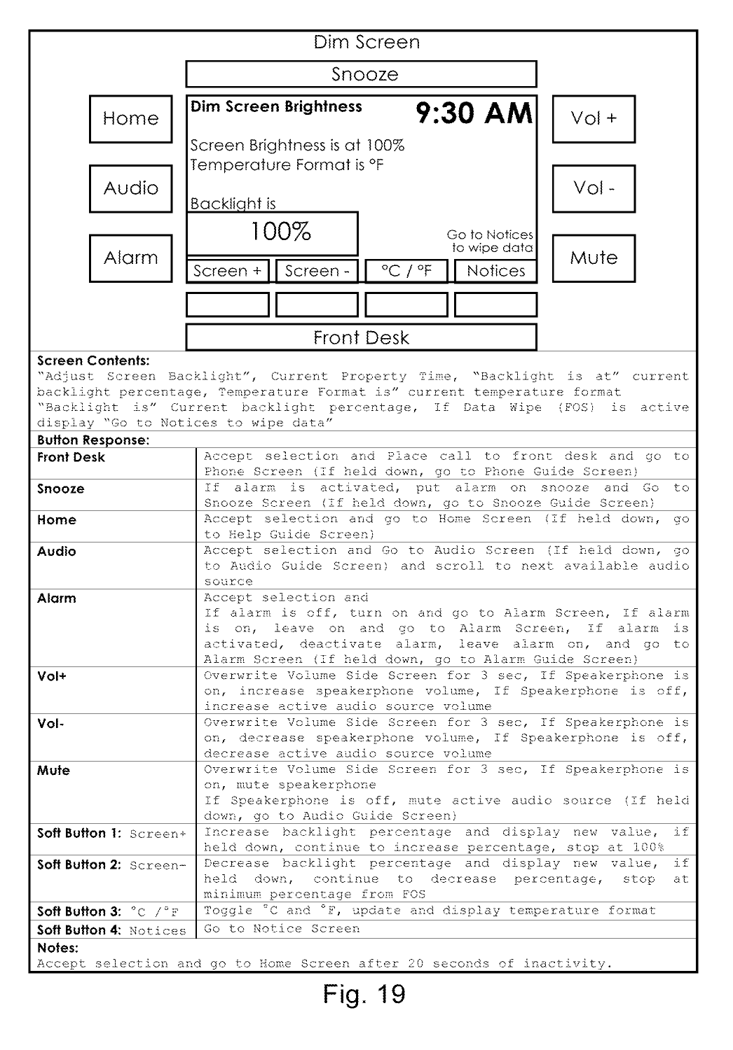

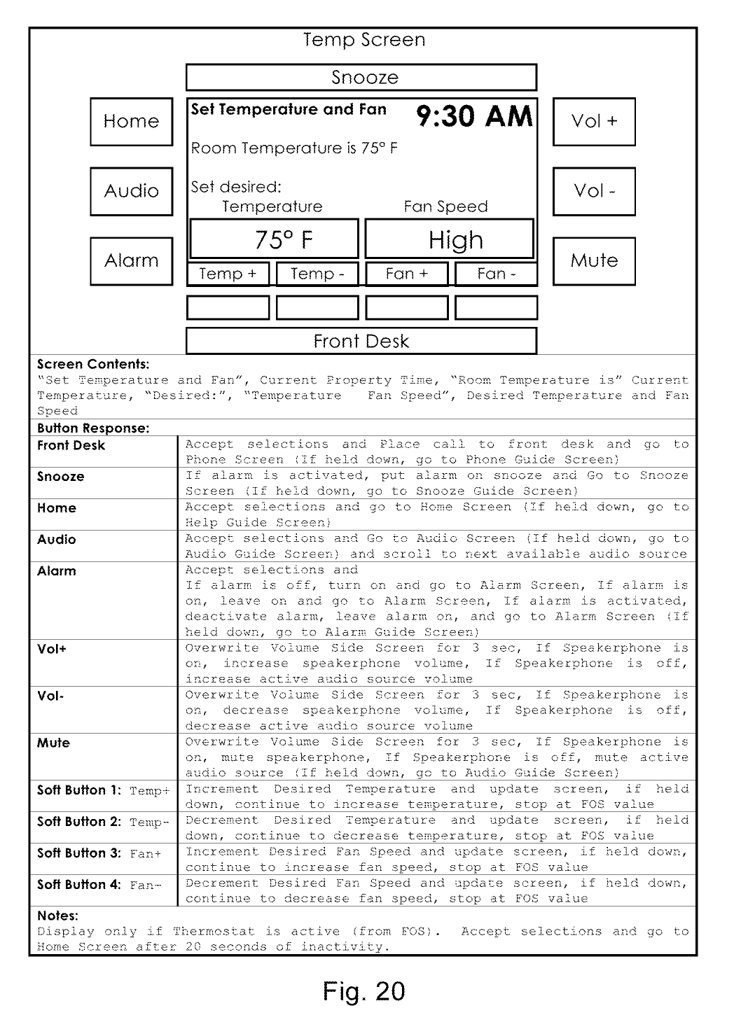

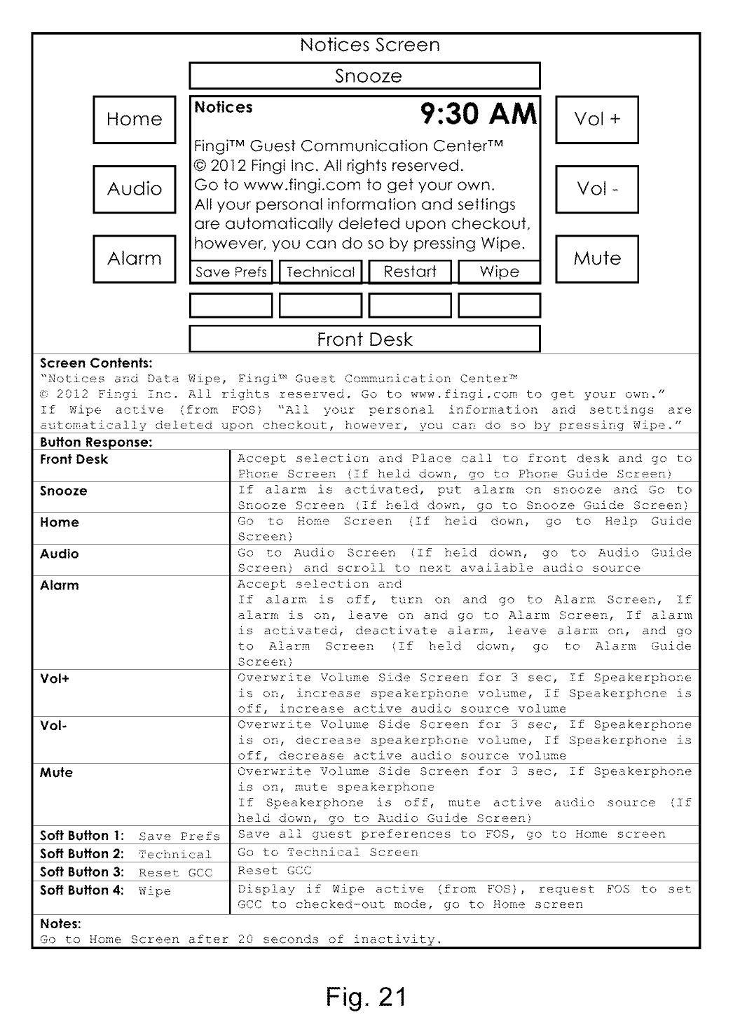

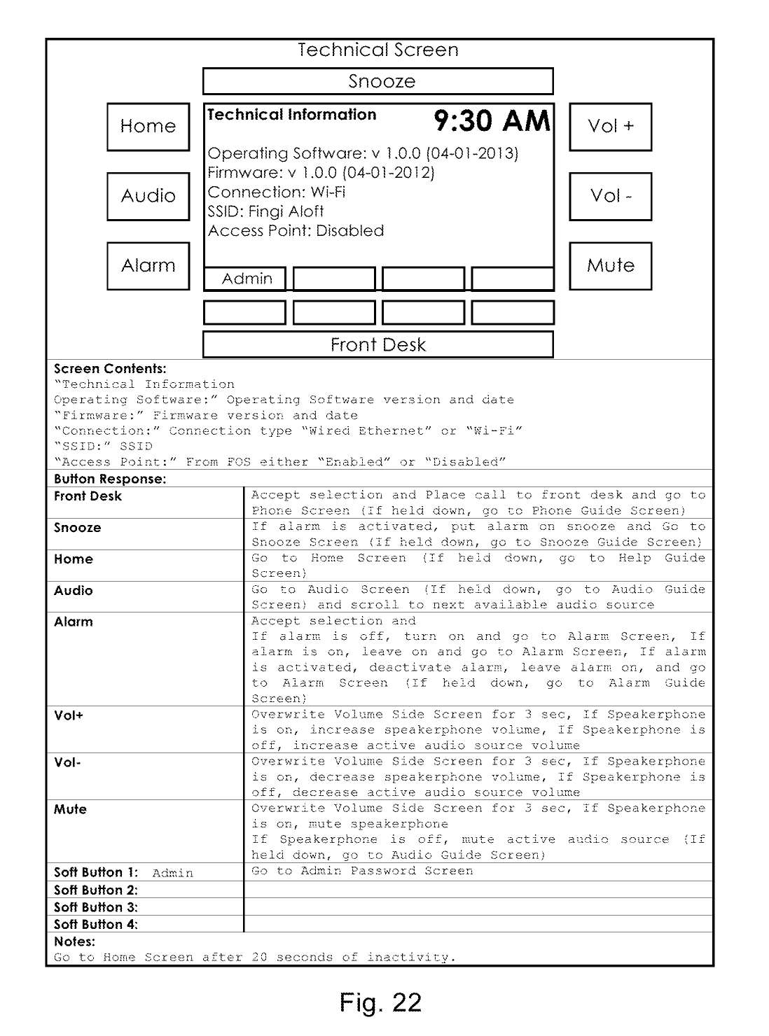

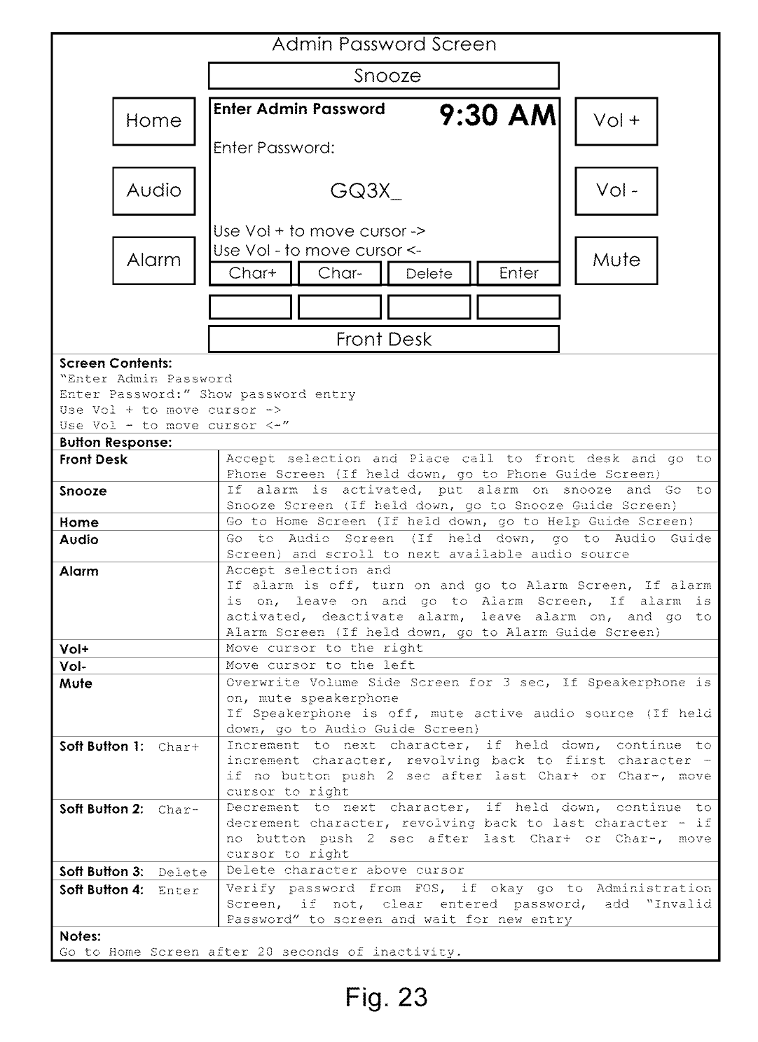

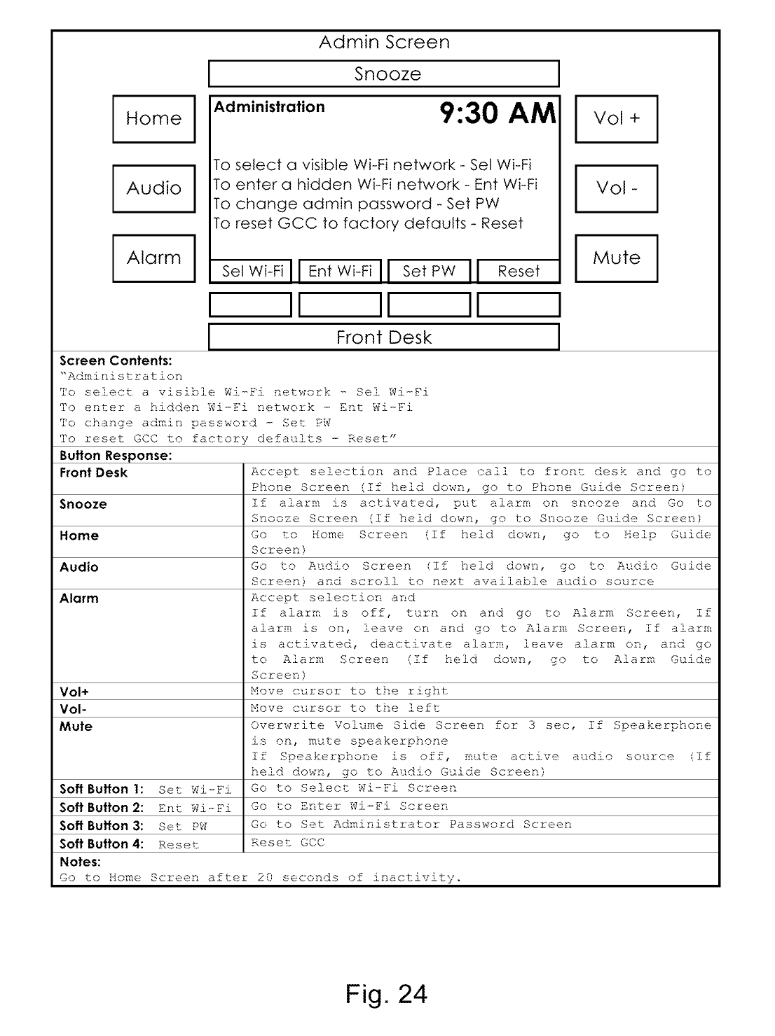

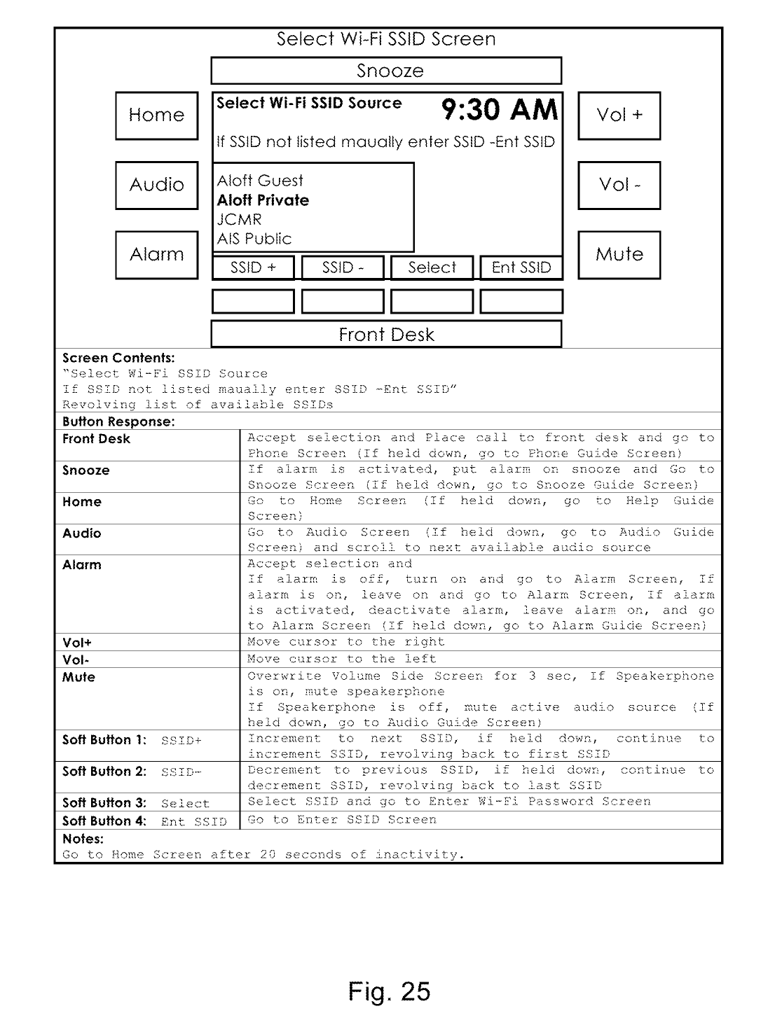

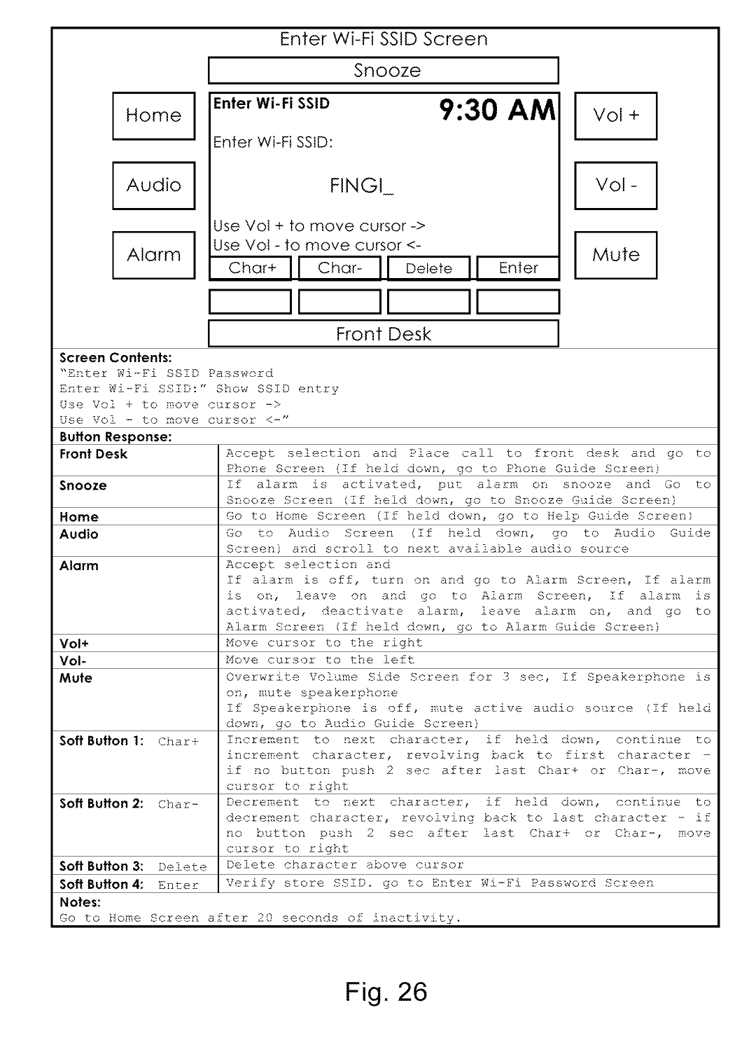

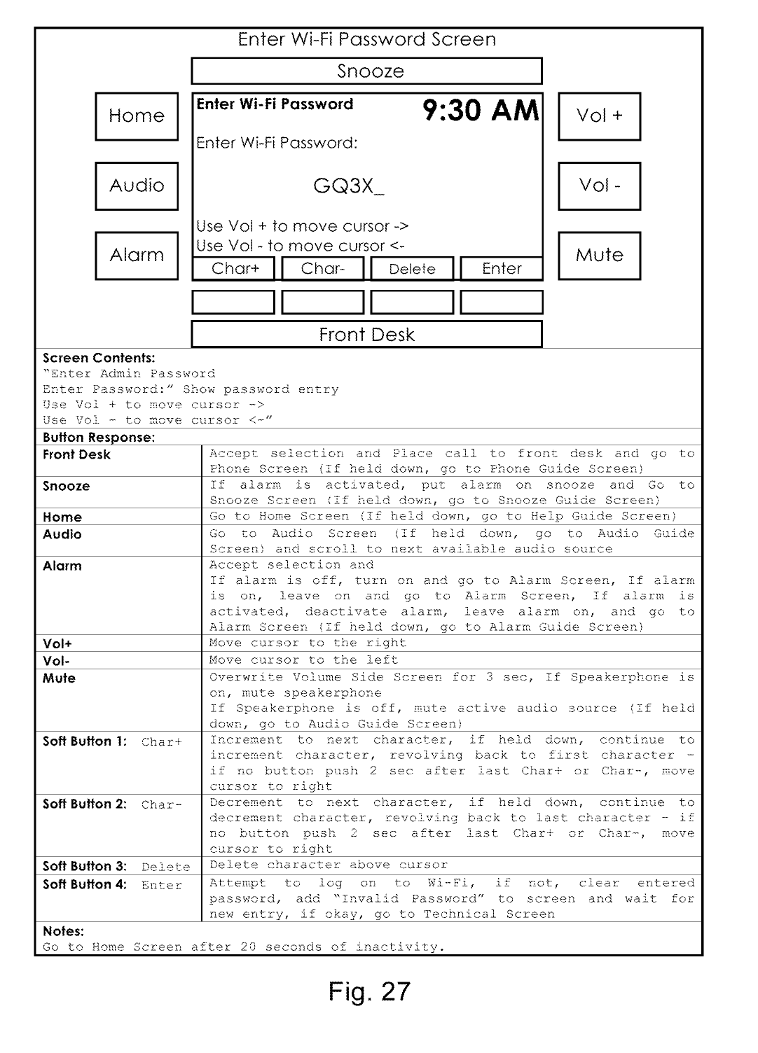

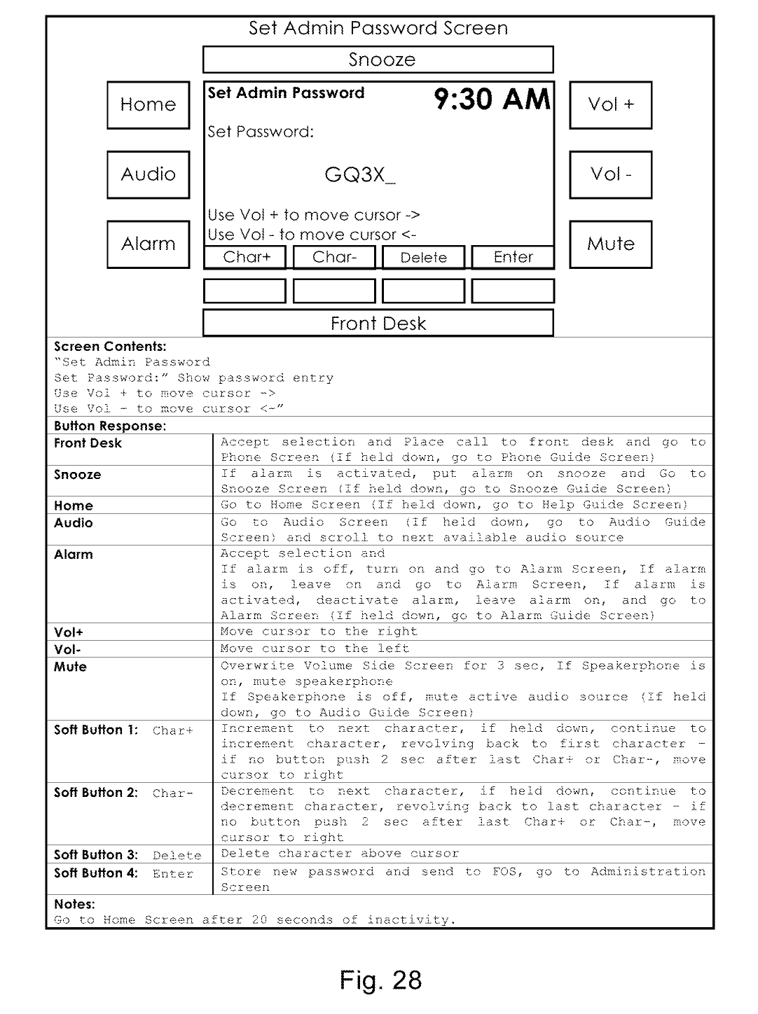

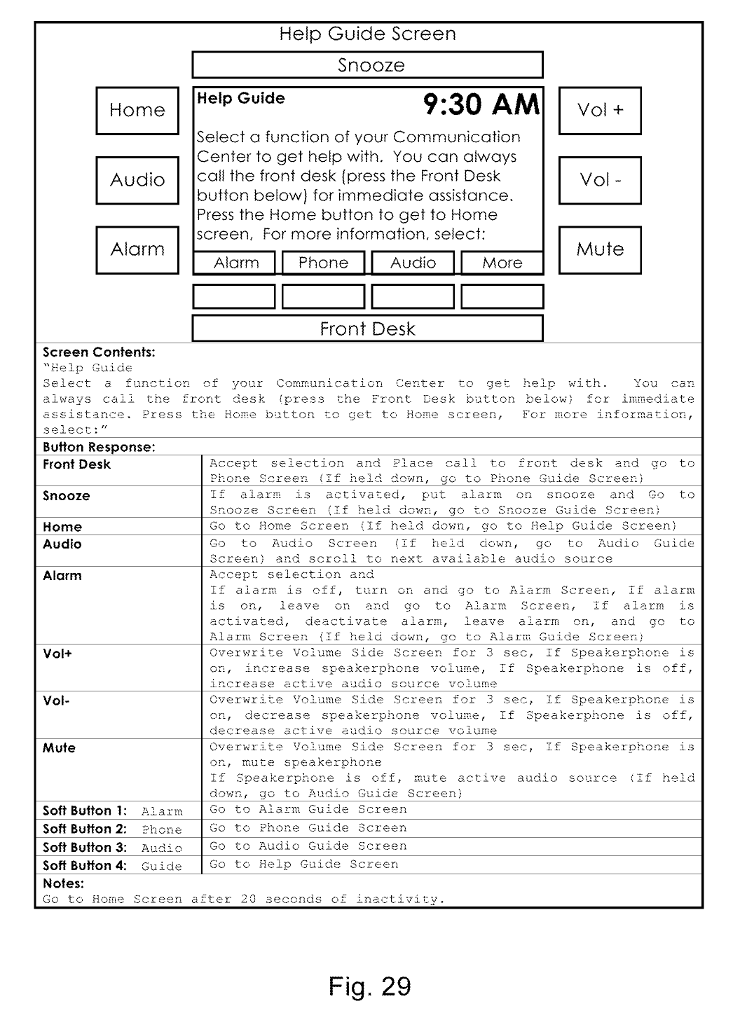

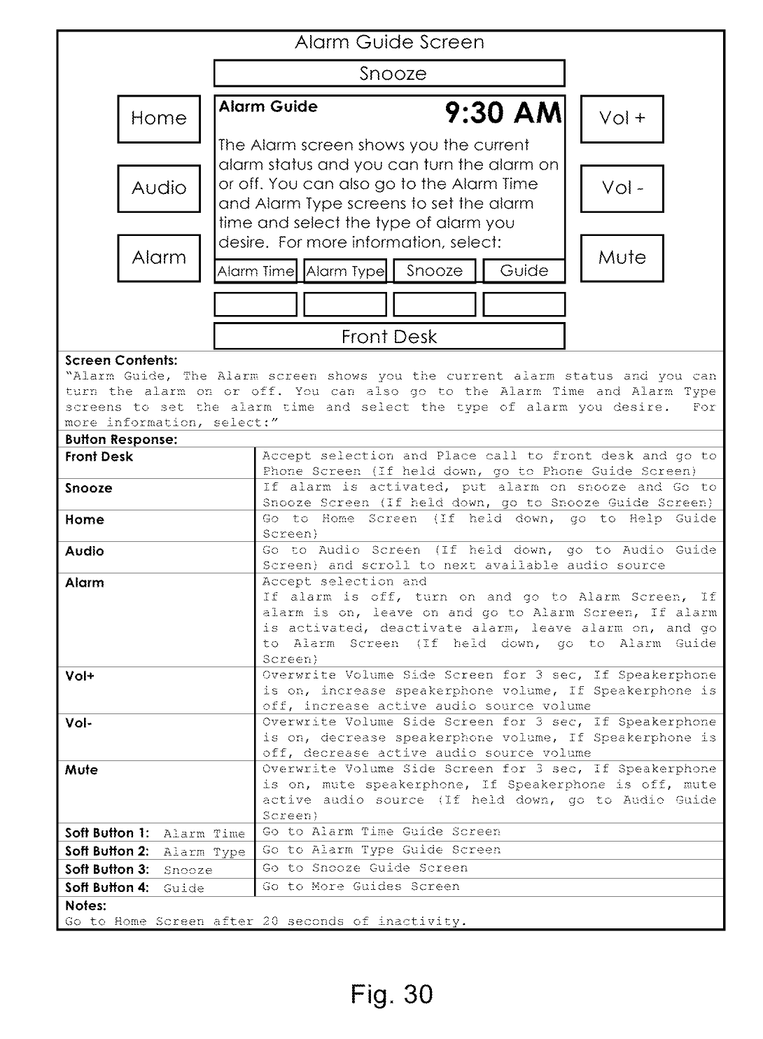

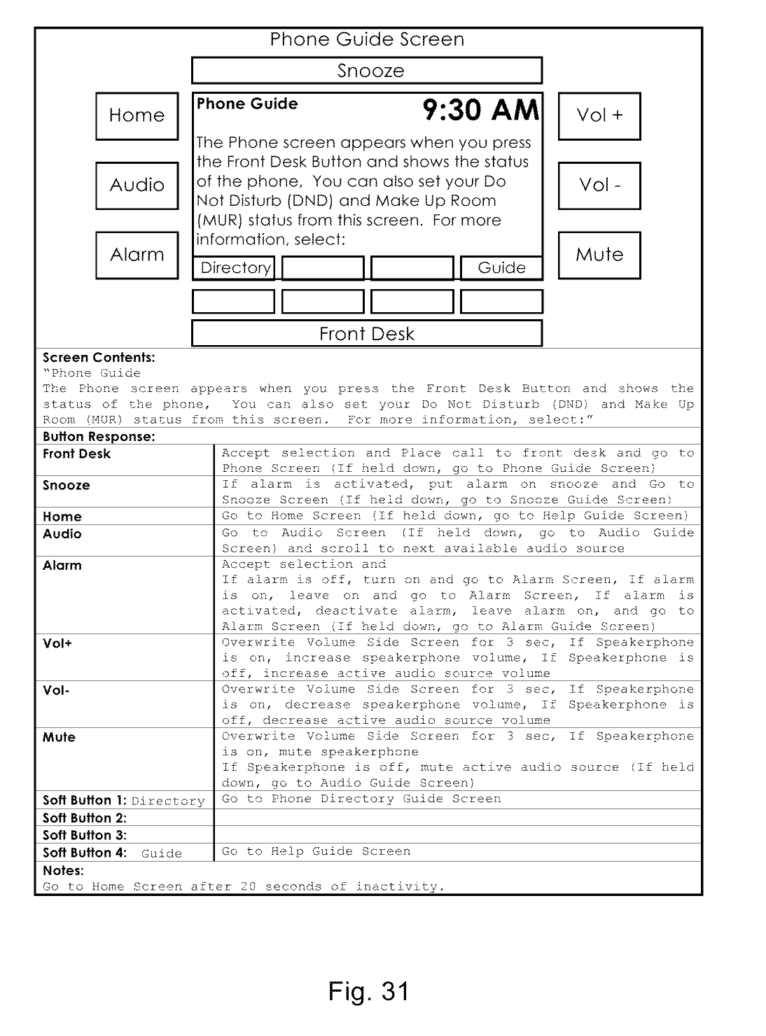

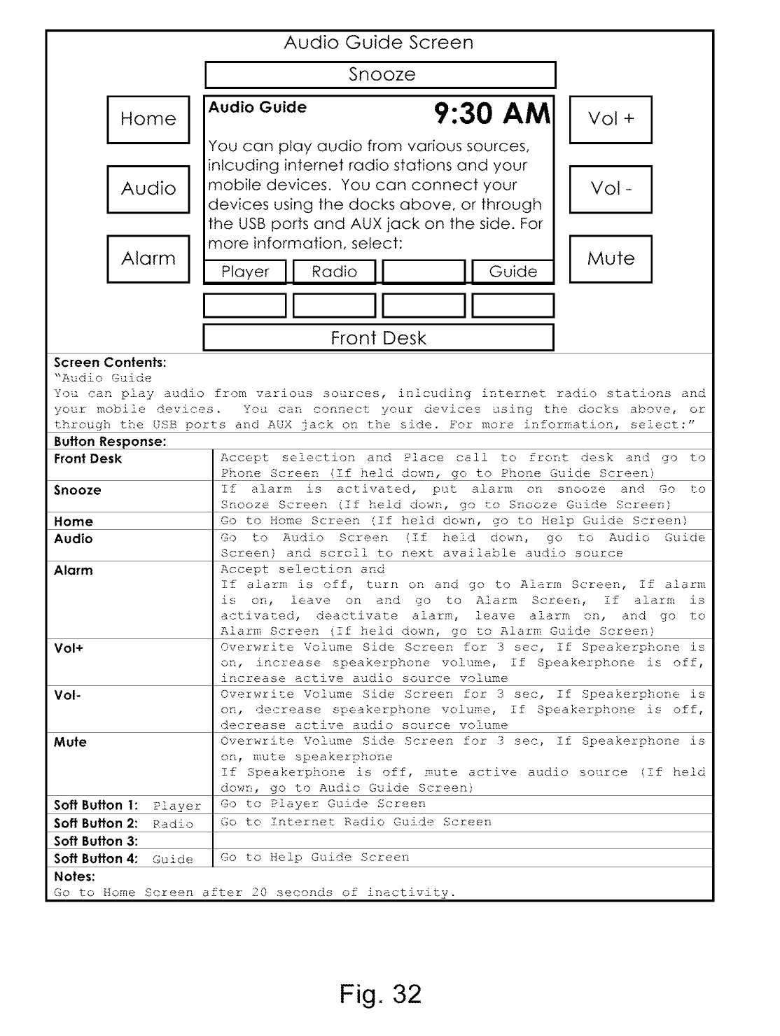

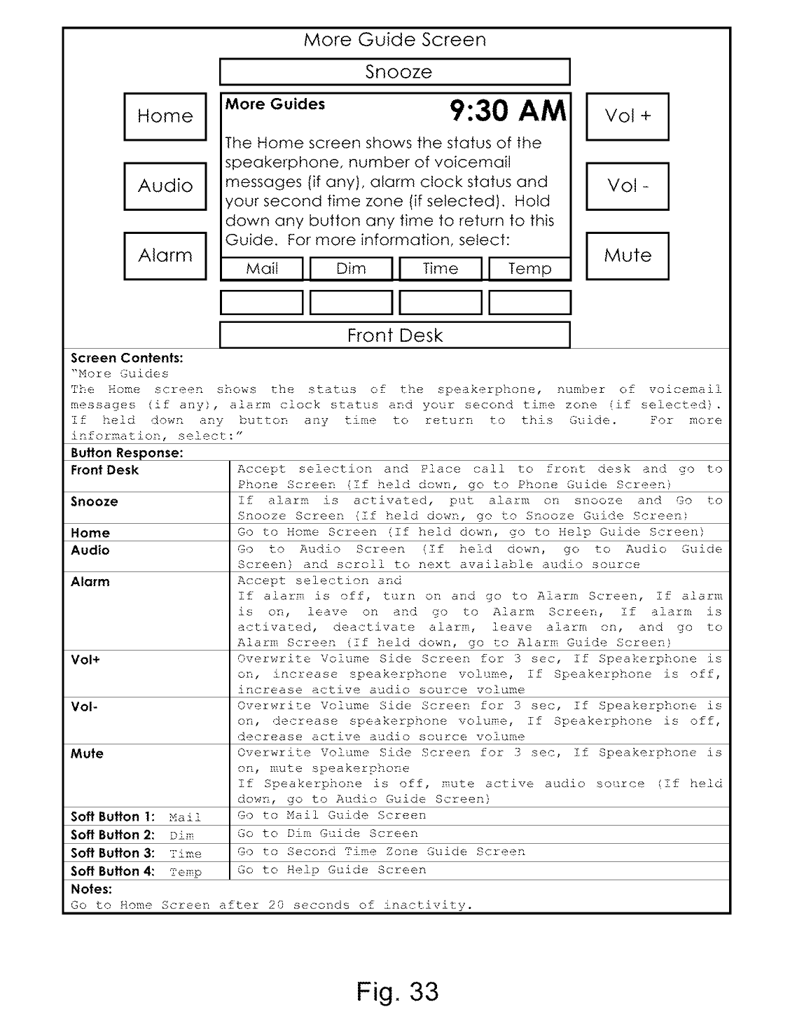

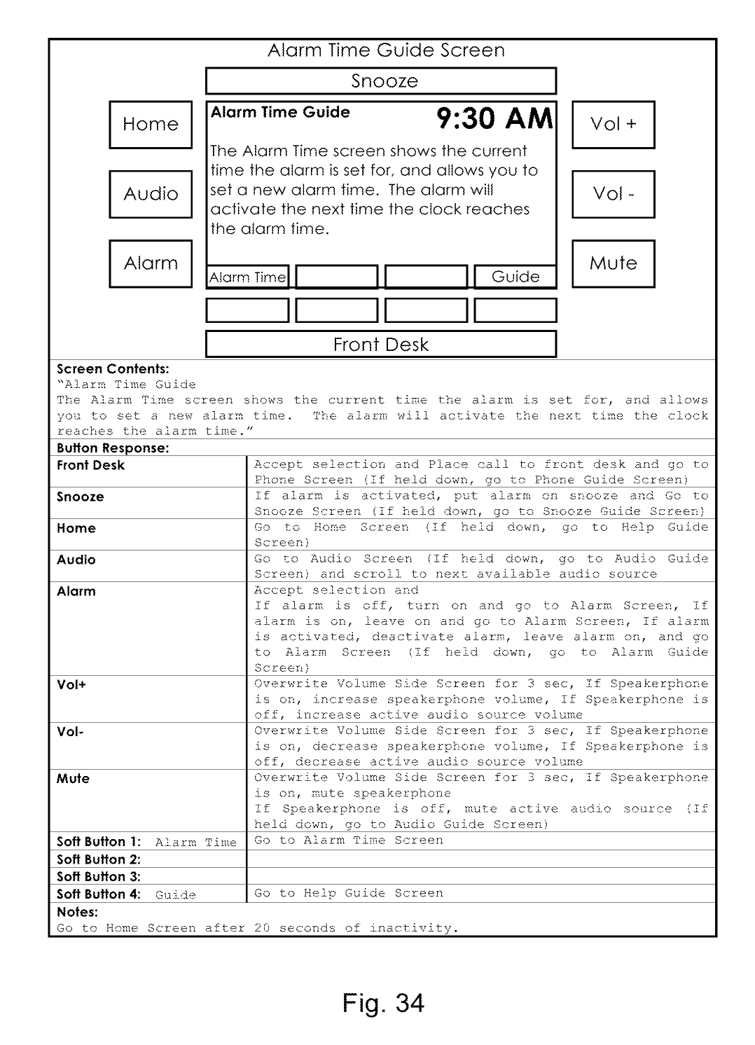

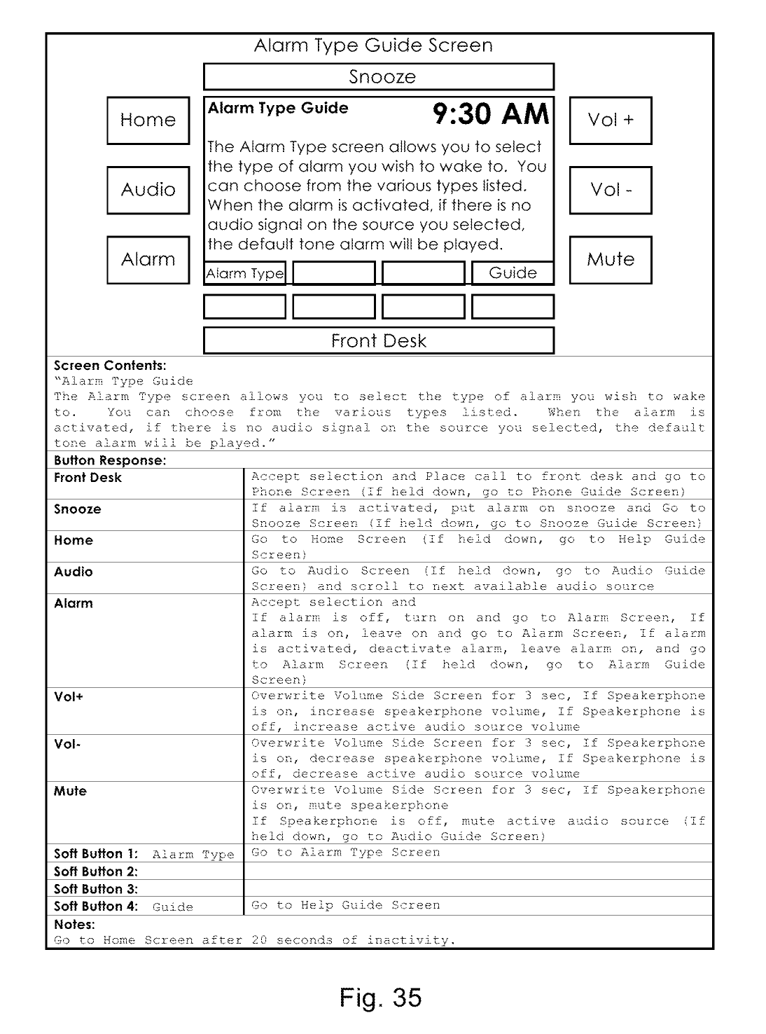

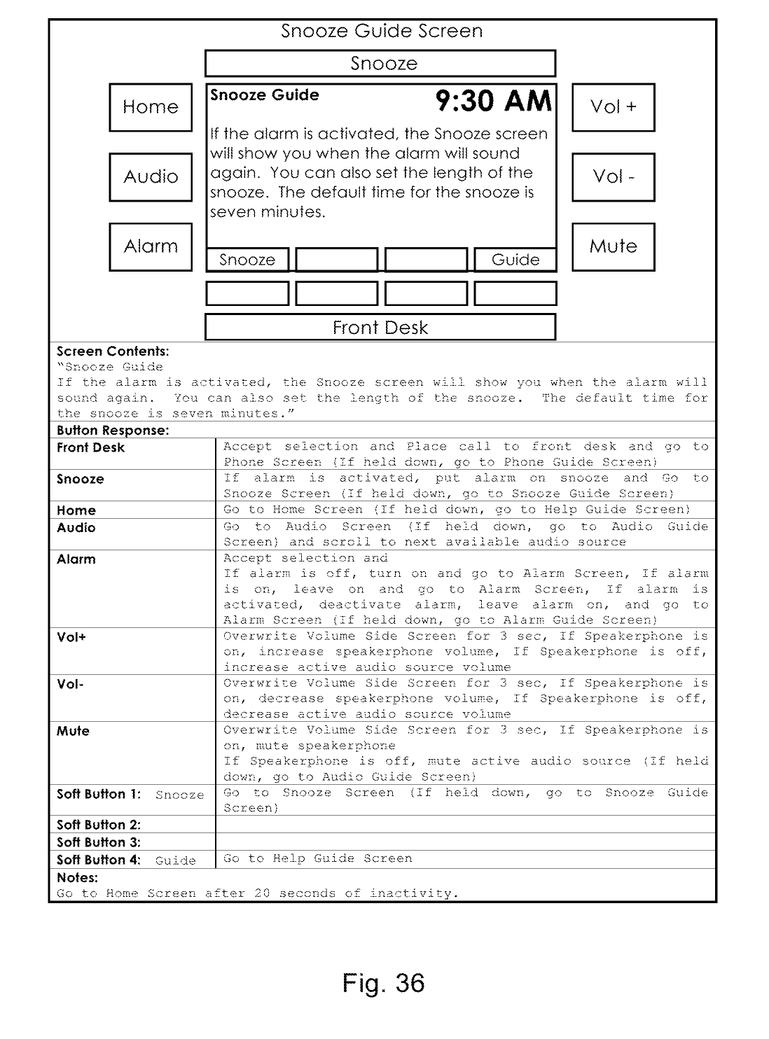

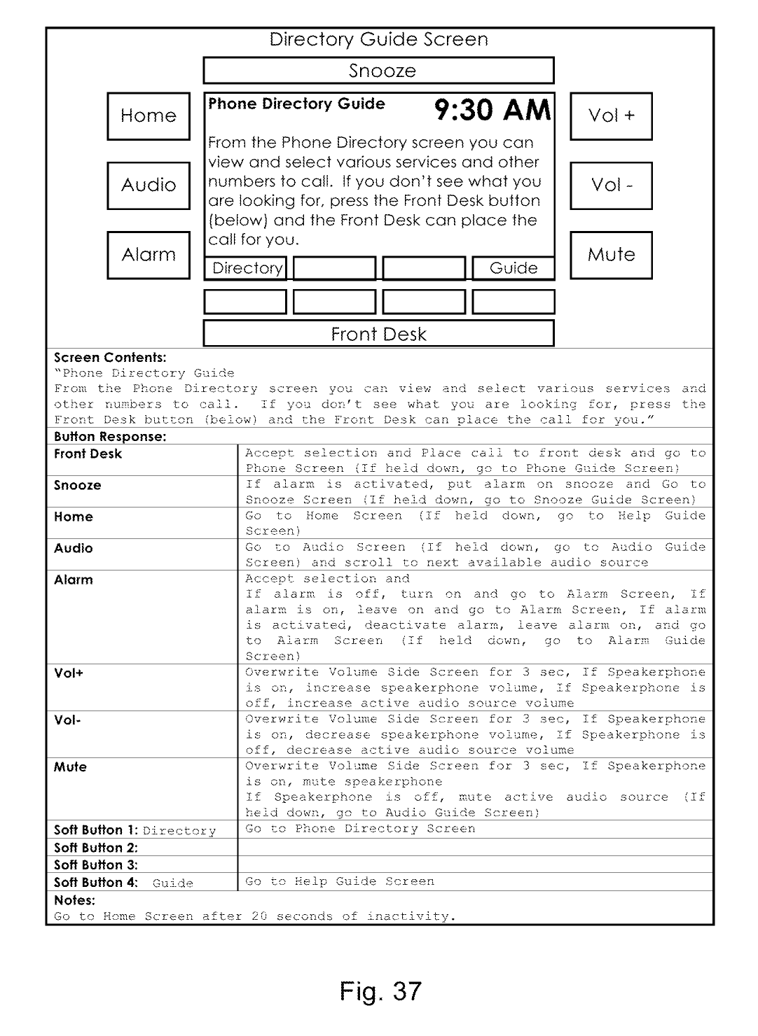

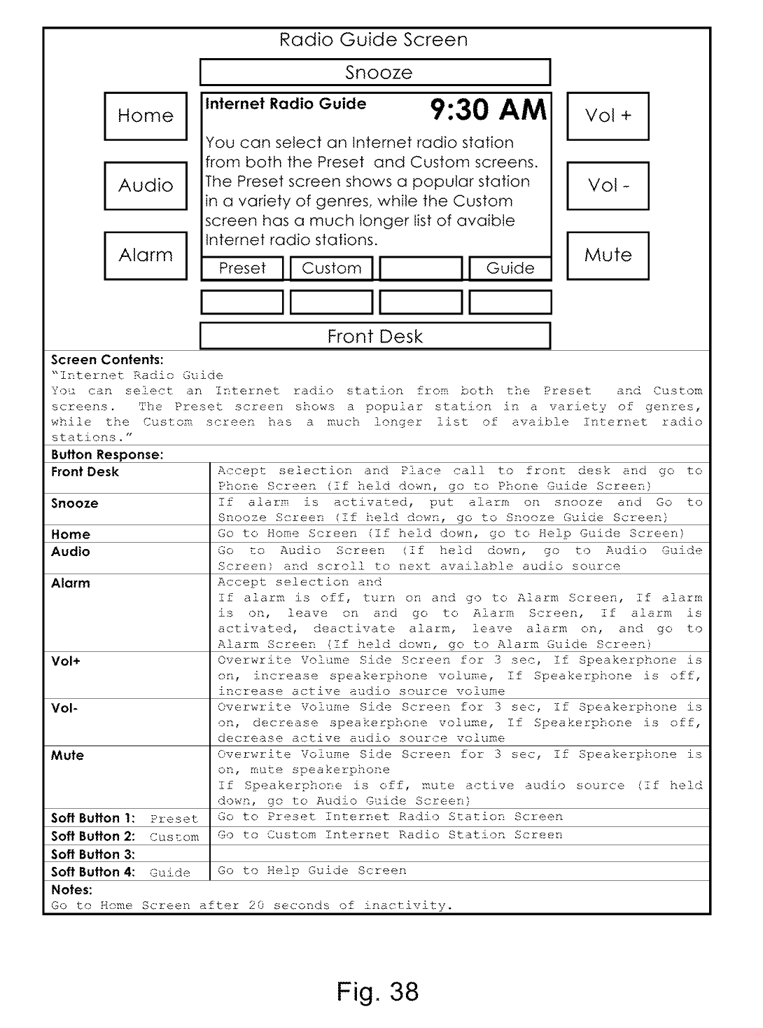

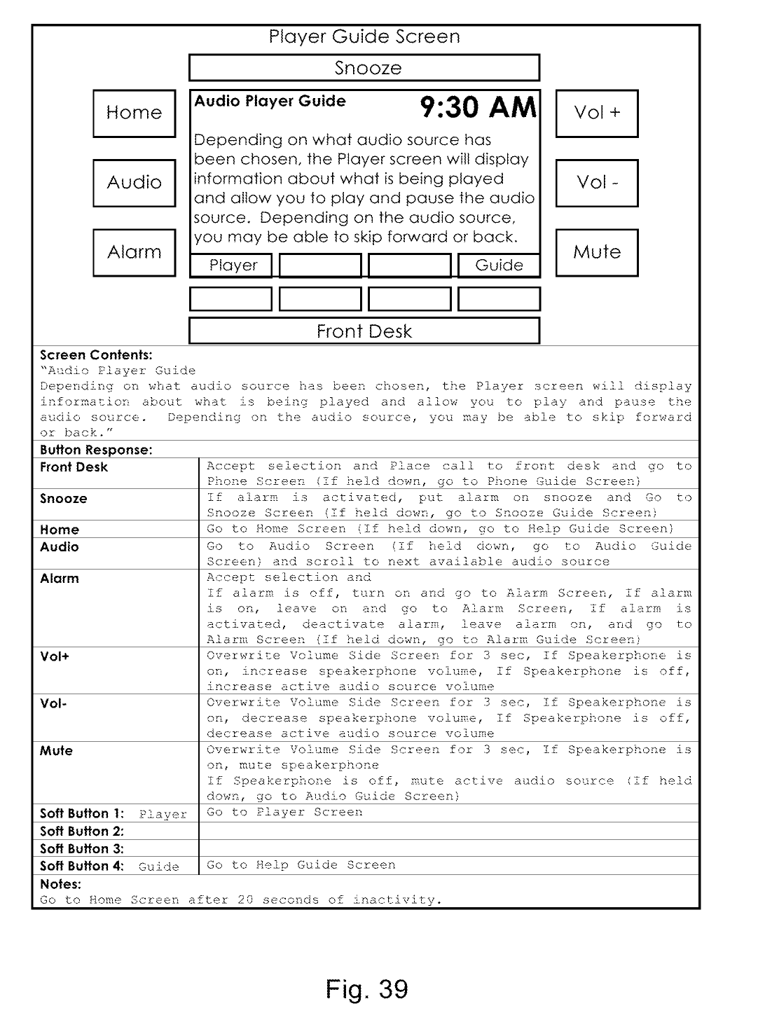

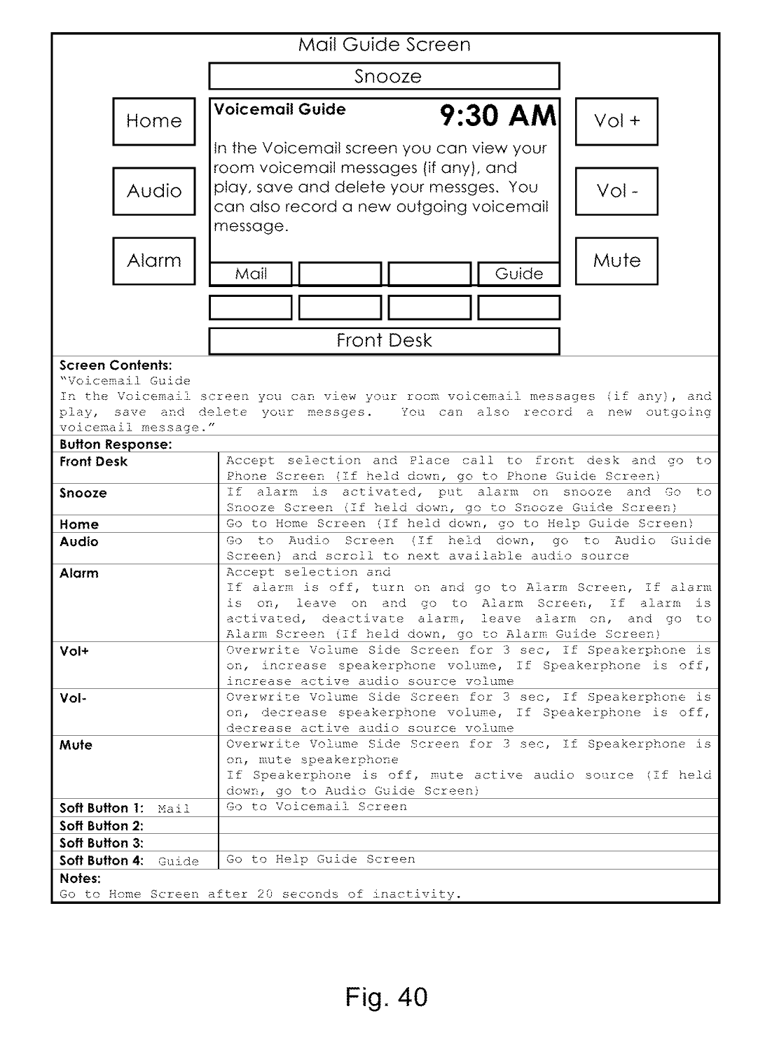

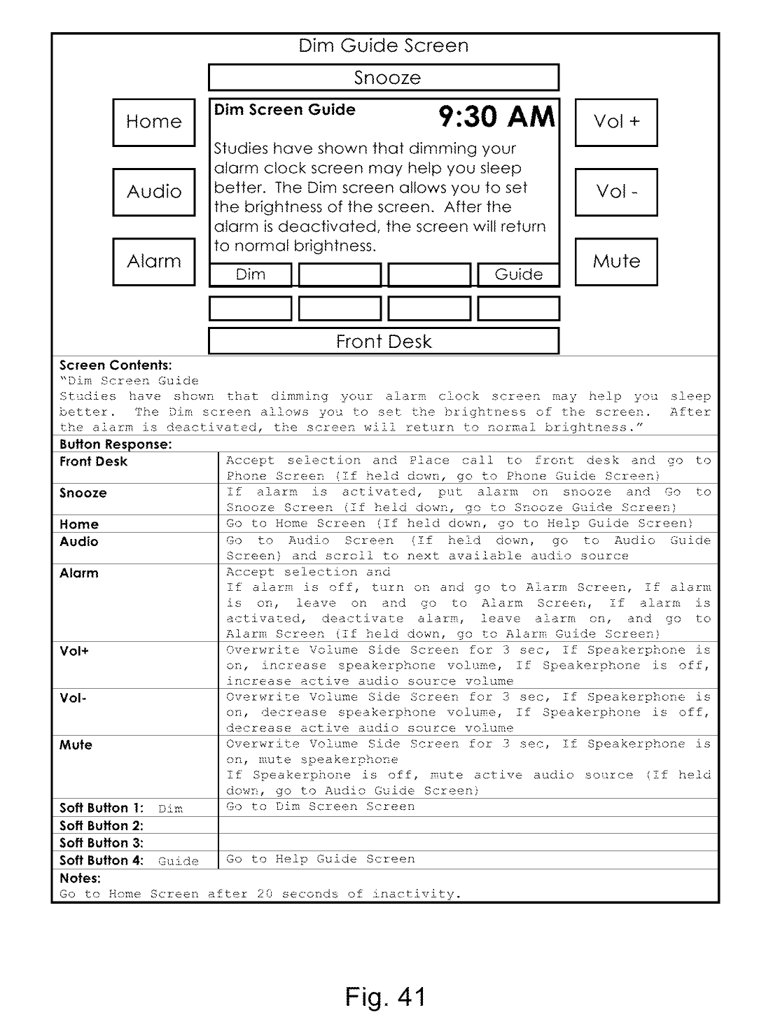

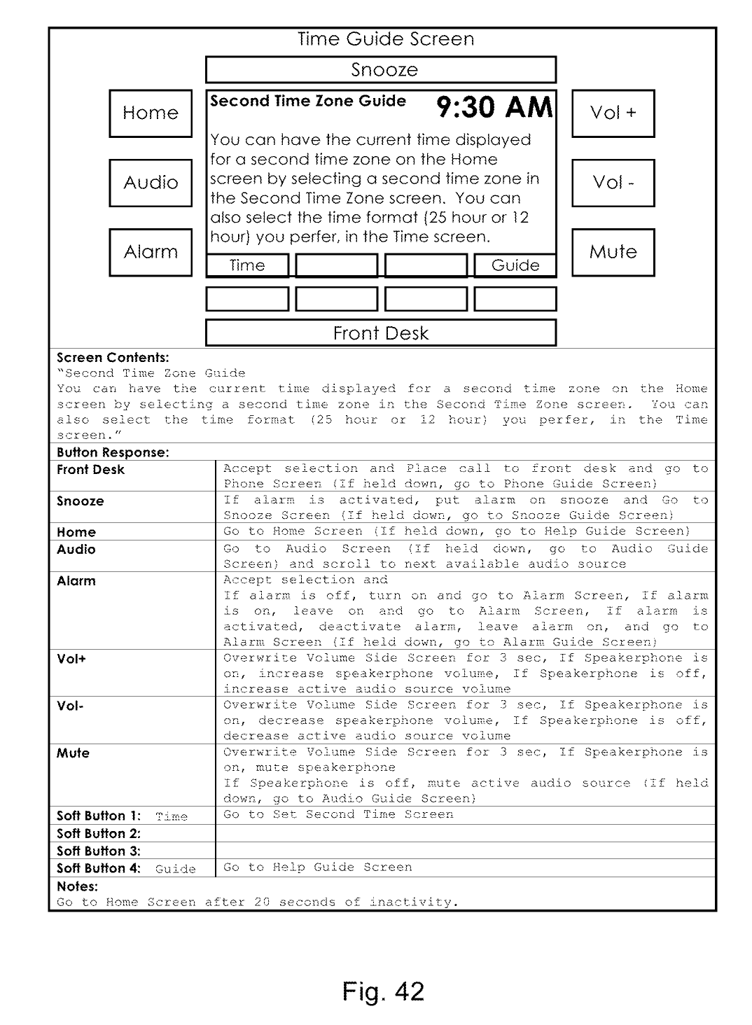

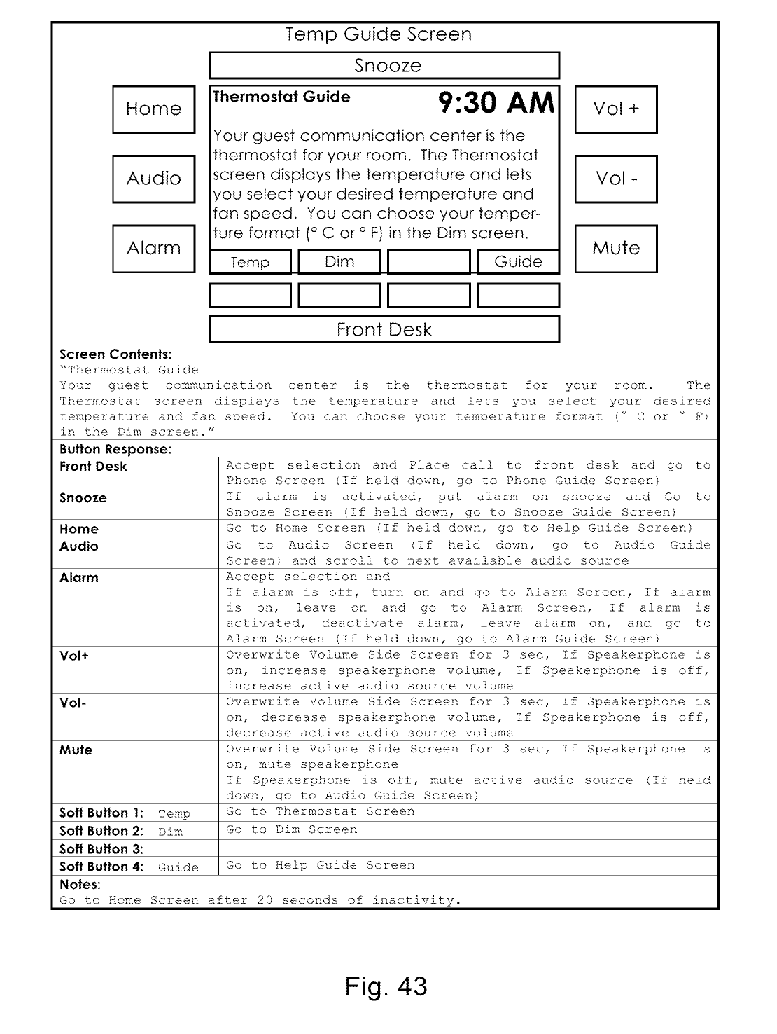

FIGS. 5-43 illustrate the preferred embodiment of the display and input software in particular operating modes. The top portion of each figure shows how the display appears to the user. The bottom half of each figure is a chart detailing the function of each of the buttons in the particular mode illustrated. Each of the functions in the chart corresponds to a particular button illustrated near the display.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A network-connected device providing the following functions to a user:
alarm clock function;
audio system function;
telephone function; and
mobile device charging function.

2. The network-connected device of claim 1, wherein the alarm clock function comprises:
displaying local time;
accepting an alarm time from said user; and
notifying said user when said local time equals said alarm time.

3. The network-connected device of claim 2, wherein the step of displaying local time:
obtaining network time code;
obtaining local time zone from network;
calculating local time
automatically updating local time based on any seasonal adjustments without any user intervention
restricting local user or any non-authorized user to change the time
obtaining user preferred time format from network; and
displaying local time in user preferred time format.

4. The network-connected device of claim 2, wherein the step of accepting an alarm time from said user comprises:
obtaining from network alarm time from user entered on another device or system.

5. The network-connected device of claim 1, wherein the audio function comprises:
receiving an audio source selection from said user; and
selecting said audio source.

6. The network-connected device of claim 1, wherein the telephone function comprises:
receiving input from user to place call; and
placing a call to a default number.

7. The network-connected device of claim 1, wherein the mobile device charging function comprises:
attaching a mobile device to at least one charging connection; and
providing power to said charging connection.

8. The network-connected device of claim 1, wherein said device receives input from user using voice commands.

9. The network-connected device of claim 8, wherein said device receives input from user using voice commands, where in the voice commands are interpreted into commands usable by the device using instructions contained within the device.

10. The network-connected device of claim 8, wherein said device receives input from user using voice commands, wherein the voice commands are interpreted into commands usable by the device by sending the voice commands over the network to a voice command processing system, and receiving over the network the commands usable by the device from the voice command processing system.

11. An electronic device comprising:
a motherboard;
a processor connected to the motherboard;
a control circuit connected to the motherboard;
a network receiver connected to the motherboard;
an electronic display connected to the motherboard;
a speaker system connected to the motherboard;
an input device connected to the motherboard; and
one or more modules for docking portable electronic devices.

12. The electronic device in claim 12 where the input device is one or more of the following:
one or more electronic buttons;
a touch screen; and
a voice control module.

13. The electronic device in claim 12 where the modules for docking portable electronic device is modular, and so it can be changed out for other modules in order to accommodate different devices.

14. The electronic device in claim 12, further comprising a temperature sensor for determining ambient room temperature.

15. The electronic device in claim 12, further comprising one or more wireless antennas for connecting to devices wirelessly.

16. The electronic device in claim 12, further comprising one or more wireless antennas and one or more of the following:
providing a Wi-Fi hotspot; and
receiving an internet connection through an existing Wi-Fi hotspot.

17. The electronic device in claim 12, further comprising one or more USB ports to connect to portable devices via a USB cable.

18. The electronic device in claim 12, further comprising an USB phone handset.

19. The electronic device in claim 12, further comprising a case for housing the electronic components.

20. The electronic device in claim 19, where the case has one or more docking slots in order to orient connected electronic devices.
